(19) United States
(12) Patent Application Publication
(10) Pub. No.: US 2020/0016654 A1
(43) Pub. Date: Jan. 16, 2020

(54) FURNACE HEATER

(71) Applicant: Desktop Metal, Inc., Burlington, MA (US)

(72) Inventors: Nathan Woodard, Medford, MA (US); Christina Clowes, Williamsville, NY (US); Matthew Dwyer, Lancaster, NY (US); Douglas White, East Amherst, NY (US)

(73) Assignee: Desktop Metal, Inc.

(21) Appl. No.: 16/577,392

(22) Filed: Sep. 20, 2019

Related U.S. Application Data
(63) Continuation-in-part of application No. PCT/US2019/030655, filed on May 3, 2019.
(60) Provisional application No. 62/666,196, filed on May 3, 2018.
(60) Provisional application No. 62/734,980, filed on Sep. 21, 2018.

(51) Int. Cl. B22F 3/00; B33Y 40/00; F27D 11/02; H05B 3/66; H05B 7/14; H05B 3/64; H05B 3/14; H05B 3/08

(52) U.S. Cl. CPC B22F 3/003; B33Y 40/00; F27D 11/02; H05B 3/66; B22F 3/008; H05B 3/64; H05B 3/141; H05B 3/08; H05B 7/14

(57) ABSTRACT

A furnace heater includes a first conductive lead, a second conductive lead spaced apart from the first conductive lead by a first distance, and a first helical resistive heater element connected to the first conductive lead. The furnace heater also includes a second helical resistive heater element connected to the second conductive lead and to the first helical resistive heater element, the second helical resistive heater element spaced apart from the first helical resistive heater by a second distance, wherein the first distance is at least twice the second distance.

### CROSS-REFERENCE TO RELATED APPLICATIONS

This is a continuation-in-part of pending international application PCT/US2019/030655, filed May 3, 2019, which claims the benefit of priority of U.S. Provisional Application No. 62/666,196, filed May 3, 2018, and this application claims the benefit of priority of U.S. Provisional Application No. 62/734,980, filed Sep. 21, 2018, the entireties of which are each incorporated by reference into this application.

### DESCRIPTION

### Technical Field

Various aspects of the present disclosure relate generally to furnace heaters, and particularly for furnaces configured to operate in vacuum conditions.

### Background

Metal injection molding (MIM) is a metalworking process useful in creating a variety of metal objects. A mixture of powdered metal and one or more binders (e.g., a polymer such as polypropylene or wax) may form a “feedstock” capable of being molded, when heated, into the shape of a desired object. The initial molded part, also referred to as a “green part,” may then undergo a preliminary debinding process (e.g., chemical debinding or thermal debinding) to remove primary binder while leaving secondary binder intact, followed by a sintering process. During sintering, the part may be heated to vaporize and remove the secondary binder (thermal debinding) and brought to a temperature near the melting point of the powdered metal, which may cause the metal powder to densify into a solid mass, thereby producing the desired metal object.

Additive manufacturing, such as three-dimensional (3D) printing, includes a variety of techniques for manufacturing a three-dimensional object via a process of forming successive layers of the object. Three-dimensional printers may in some embodiments utilize a feedstock comparable to that used in MIM, thereby creating a green part without the need for a mold. The green part may then undergo debinding and sintering processes to produce the object.

In addition to MIM based additive manufacturing, there are systems using powder beds and loose powder, optical resin curing, and others. These methods, and others, may involve the use of a furnace to produce the final part or to enhance the properties of the part. Materials used to form the part may include ceramics and composites, as well as metals. Additionally, conventional materials may derive benefits from furnace processing. However, conventional heaters may require significant surface area, complicating the placement of the heater(s) in a furnace. In some applications, heaters may develop electrical shorts between conductive portions of the heater. Shorts may occur more frequently in furnaces in which electrodes are closely spaced. Additionally, the use of heaters in a vacuum may also increase the tendency of the heater(s) to experience shorts. A portion of the heater between a relatively colder portion of the heater and the relatively hot portion of the heater, such as a conductive portion of the heater, may tend to experience shorts. Additionally, macroscopic deposits may tend to generate on heaters employed in a vacuum furnace. The macroscopic deposits may be associated with shorts or other undesired discharge activity.

Industrial applications of silicon carbide (SiC) heating elements are known, for example from “Type SER and TSR, SiC Spiral Heating Elements,” as illustrated in I Squared R Element Co, Inc. brochure ST-SER-Rev. 5.doc. Exemplary known spiral type SiC heating elements may include an outer diameter, an inner diameter, and a spiral groove or cut about a portion of the circumference forming an electronic pathway from one leg-end post to another leg-end post. Electronic coupling devices are directly clamped to the ends of the posts for transmission of electrical current to permit resistive heating in the spiral groove-region.

Conventional heating elements may be brittle so that connection of electronic/electric coupling devices may cause pressure under tension from a hose clamp, which may be resisted by an electrically insulating inner plug. In an arrangement with a furnace, with a plurality of heating elements from a top-down suspension mode, a further insulating monolithic collar may be provided to secure heating elements in position on the furnace. As a further concern, conventional collars may be difficult to secure, and may provide operational difficulties.

As an additional concern, in certain applications, gaseous chemical residues may be generated from the thermal process (inside a kiln, oven etc.) and condense on the relatively colder ends of conventional electric coupling devices. This residue may detrimentally affect operation of the furnace and heaters, including the formation of electrical arcs across a gap located between the end portions of the electrical coupling device. Electrical arcs across this gap (such as a slit or slot) between narrow end portions can result in catastrophic failure and loss of the heating element. Thus, conventional devices may result in large financial costs associated with the time necessary for repair, as well as costs associated with replacement of the heating device and equipment. As the heaters may experience an irreversible phase transformation as they reach operational temperature, and thus, after cooling for repair, repair of a single element can require the complete replacement of the entire kiln or oven.

An exemplary gas igniter is disclosed in U.S. Pat. No. 3,928,910 to Perl (“the '910 patent”). The gas igniter of the '910 patent includes small end-grooves formed by cutting at the end of each leg-end of a spiral heating element. Electrical connectors are held in place therein, and using a spray bonding process, spray bonded material is secured in place forming a reasonably secure electrical connection between connectors and ends of a heating element. While useful in some circumstances, this technique may have a detrimental effect on quality control, may experience substantial thermal degradation, may allow very little surface connection, and may cause electrical arcing. These and other conventional heaters may provide only a temporary electronic linkage when employed within a hot furnace atmosphere which may experience temperatures as high as 1600° C.

The apparatus and systems of the current disclosure may rectify one or more of the deficiencies described above, or address other aspects of the prior art.

### SUMMARY OF THE DISCLOSURE

Examples of the present disclosure relate to, among other things, systems and methods for sintering objects produced by additive manufacturing. Each of the examples disclosed herein may include one or more of the features described in connection with any of the other disclosed examples.

In one aspect, a furnace heater may include a first conductive lead, a second conductive lead spaced apart from the first conductive lead by a first distance, and a first helical resistive heater element connected to the first conductive lead. The furnace heater may also include a second helical resistive heater element connected to the second conductive lead and to the first helical resistive heater element, the second helical resistive heater element spaced apart from the first helical resistive heater by a second distance, wherein the first distance is at least twice the second distance.

In another aspect, a furnace may include a thermal insulation layer, a vacuum pump configured to maintain the furnace at a pressure that is lower than a pressure outside the furnace and a furnace heater extending from a proximal end to a distal end. The furnace heater of the furnace may include a first conductive lead, a first helical resistive heater electrically connected to the first conductive lead, and a second conductive lead spaced apart from the first conductive lead by a first distance. The furnace heater may also include a second helical resistive heater electrically connected to the second conductive lead and spaced apart from the first helical resistive heater by a second distance, wherein the first distance is at least twice the second distance.

In yet another aspect, a furnace heater may include a first electrical insulator, a first conductive lead extending within the first electrical insulator, and a second conductive lead. The furnace heater may also include a first helical resistive heater element connected to a distal end of the first conductive lead, a second helical resistive heater element connected to a distal end of the second conductive lead and to the first helical resistive heater element, and an electrode formed at a proximal end of the first conductive lead.

According to yet another aspect, a heating element system may include a spiral or helical heating element joined to a bridge assembly which extends to offset terminal ends having end-grooves for receiving metal bonded electrical wires for power transfer. Electrical conductance may be lower in the bridge assembly and the terminal ends than in the spiral heating element, allowing for localized controlled heating. Elements may be combined in a monolithic assembly with ceramic paste, and the wires may secured to the terminal ends using a metalized spray bonding method.

According to yet another aspect, the bridge assembly or arrangement may include spiral ends entirely or fully within a relatively hot zone, thereby preventing gaseous chemical residues from condensing therein. For example, gaseous chemical residues may be prevented from condensing, at least partially because the temperature is too high (e.g., much hotter than the relatively colder ends that may form the electrical coupling).

According to yet another aspect, a thermal bridge assembly or arrangement may be particularly useful in a hot environment (e.g., kiln, oven, etc.) where organic binders may be removed from pressed or extruded parts formed from powdered metal or ceramic particle compositions. The above-described problems may be particularly acute when rapid binder removal from printed (for a 3D printed part, etc.) components is performed, at least because the temperatures involved in rapid binder removal may cause a rapid buildup of carbonaceous deposits.

According to yet another aspect, a heating element system may include: an electrically conductive spiral helix heating element having a spiral hot end and an opposed cool ending having a first cool side and a second cool side; the electrically conductive spiral helix heating element having a first heating element electrical resistance; an electrically conductive first bridge member chemically bonded to and extending from the first cool side and away from the hot end; an electrically conductive second bridge member chemically bonded to and extending from the second cool side and away from the hot end and the first bridge member; each first bridge and second bridge having a second bridge electrical resistance; the second bridge electrical resistance being less than the first heating element electrical resistance; a first electric terminal extending from the first bridge member; a second electric terminal extending from the second bridge member; each of the first electrical terminal and the second electric terminal having a third electric terminal electrical resistance; the third electrical terminal electrical resistance being the same as or less than the second bridge electrical resistance; a first electrical connector joined to the first electrical terminal at a first receiving profile geometry; a second electrical connector joined to the second electrical terminal at a second receiving profile geometry; each of the first electrical connector and the second electrical connector having a fourth electrical resistance; and the fourth electrical resistance being the same as or less than the third electrical terminal electrical resistance.

According to yet another aspect, a method of assembling a heating element system may include the steps of: providing an electrically conductive spiral helix heating element having a spiral hot end and an opposed cool ending having a first cool side and a second cool side; the electrically conductive spiral helix heating element having a first heating element electrical resistance; providing an electrically conductive first bridge member chemically bonded to and extending from the first cool side and away from the hot end; providing an electrically conductive second bridge member chemically bonded to and extending from the second cool side and away from the hot end and the first bridge member; each of the first bridge and the second bridge having a second bridge electrical resistance; the second bridge electrical resistance being less than the first heating element electrical resistance; providing a first electric terminal extending from the first bridge member; providing a second electric terminal extending from the second bridge member; each of the first electrical terminal and the second electric terminal having a third electric terminal electrical resistance; the third electrical terminal electrical resistance being the same as or less than the second bridge electrical resistance; providing a first electrical connector joined to the first electrical terminal at a first receiving profile geometry; providing a second electrical connector joined to the second electrical terminal at a second receiving profile geometry; each of the first electrical connector and the second electrical connector having a fourth electrical resistance; and the fourth electrical resistance being the same as or less than the third electrical terminal electrical resistance.

According to yet another aspect, a heating element assembly may include: an electrically conductive spiral helix heating element having a spiral hot end and an opposed cool ending having a first cool side and a second cool side; the electrically conductive spiral helix heating element having a first heating element electrical resistance; an electrically conductive first bridge member chemically bonded to and extending from the first cool side and away from the hot end; an electrically conductive second bridge member chemically bonded to and extending from the second cool side and away from the hot end and the first bridge member; each of the first bridge and the second bridge having a second bridge electrical resistance; the second bridge electrical resistance being less than the first heating element electrical resistance; a first electric terminal extending from the first bridge member; a second electric terminal extending from the second bridge member; each of the first electrical terminal and the second electric terminal having a third electric terminal electrical resistance; the third electrical terminal electrical resistance being the same as or less than the second bridge electrical resistance; a first electrical connector joined to the first electrical terminal at a first receiving profile geometry; a second electrical connector joined to the second electrical terminal at a second receiving profile geometry; each of the first electrical connector and the second electrical connector having a fourth electrical resistance; and the fourth electrical resistance being the same as or less than the third electrical terminal electrical resistance.

Both the foregoing general description and the following detailed description are exemplary and explanatory only and are not restrictive of the features, as claimed. As used herein, the terms “comprises,” “comprising,” “including,” “having,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” It should be noted that all numeric values disclosed or claimed herein (including all disclosed values, limits, and ranges) may have a variation of +/−10% (unless a different variation is specified) from the disclosed numeric value. In this disclosure, unless stated otherwise, relative terms, such as, for example, “about,” “substantially,” and “approximately” are used to indicate a possible variation of ±10% in the stated value. Moreover, in the claims, values, limits, and/or ranges of various claimed elements and/or features means the stated value, limit, and/or range +/−10%. The terms “object,” “part,” and “component,” as used herein, are intended to encompass any object fabricated using the additive manufacturing techniques described herein.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 is a schematic view an exemplary furnace heater.

FIG. 2 is a perspective view of exemplary heater elements of a furnace heater.

FIG. 3 is a front view of an exemplary furnace heater including a pair of conductive leads.

FIG. 4 is a front view of an exemplary furnace heater including a pair of electrical insulators.

FIG. 5 is a front view of an exemplary furnace heater including a housing and a pair of potted ends.

FIG. 6 is a cross-sectional view of an exemplary furnace heater including a pair of connectors.

FIG. 7 is an exploded view of the exemplary furnace heater of FIGS. 5 and 6.

FIG. 8 is a cross-sectional view of an exemplary furnace heater including a pair of terminals.

FIG. 9 is a partial cross-sectional top view of an exemplary furnace heater.

FIG. 10 is a partial cross-sectional side view of the exemplary furnace heater of FIG. 9.

FIG. 11 is a front view of three exemplary furnace heaters in various states of assembly.

FIGS. 12A and 12B are enlarged perspective views of two respective furnace heaters of FIG. 11.

FIG. 13 is a perspective assembly schematic illustrating an insertion of a wire during assembly of an exemplary furnace heater.

FIG. 14 is a cross-sectional view along line 14-14 in FIG. 9.

FIG. 15 is a cross-sectional view along line 15-15 in FIG. 10.

FIG. 16 is a perspective view of an exemplary furnace heater from a top-down perspective.

FIG. 17 is a perspective view of an exemplary furnace heater from a bottom-up perspective.

FIG. 18 is an exploded view of an exemplary furnace and plurality of furnace heaters.

FIG. 19 is a partial cross-sectional view of the furnace and plurality of furnace heaters of FIG. 9.

FIG. 20A is a block diagram of an additive manufacturing system according to some embodiments of the disclosure.

FIG. 20B illustrates an exemplary printing subsystem of the system of FIG. 20A.

FIG. 20C illustrates an exemplary debinding subsystem of the system of FIG. 20A.

FIG. 21A is a block diagram of an additive manufacturing system according to some embodiments of the disclosure.

FIG. 21B illustrates an exemplary printing subsystem of the system of FIG. 21A.

FIG. 21C illustrates another exemplary printing subsystem of the system of FIG. 21A.

FIG. 22 illustrates an exemplary furnace subsystem of the system of FIG. 20A or FIG. 21A.

### DETAILED DESCRIPTION

Embodiments of the present disclosure include systems and methods to facilitate and improve the efficacy and/or efficiency of sintering printed objects. Reference now will be made in detail to examples of the present disclosure described above and illustrated in the accompanying drawings. Wherever possible, the same reference numbers will be used throughout the drawings to refer to the same or like parts.

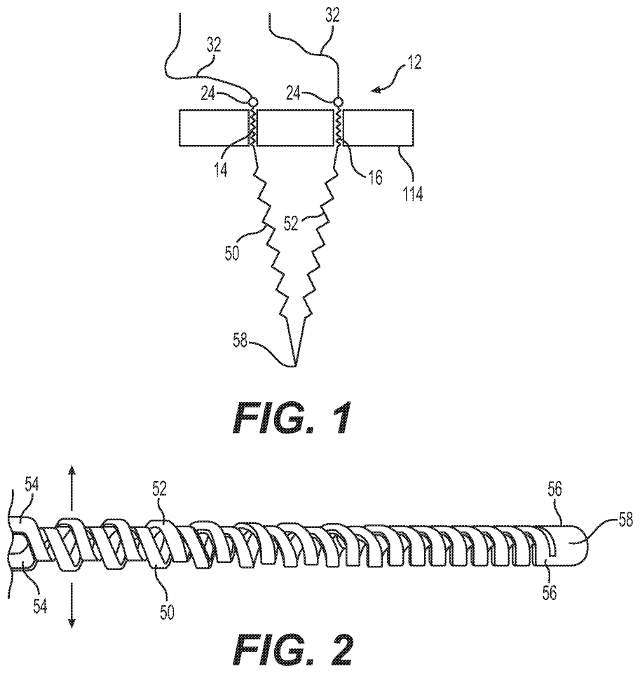

FIG. 1 is a schematic view of a furnace heater 12 according to an embodiment of the present disclosure. Furnace heater 12 may include a first conductive lead 14, a second conductive lead 16, a pair of terminals or electrodes 24, and a pair of heater elements 50, 52. Conductive leads 14, 16 may form a proximal end of heater 12, while joined distal ends of heater elements 50 and 52 may form a distal end of furnace heater 12. The distal ends of heater elements 50 and 52 may form a bridge or base 58 at the distal end of heater 12 where heater elements 50 and 52 are mechanically and electrically connected to each other. In other aspects, heater elements 50 and 52 may be portions of a continuous heater element with an inflection point at base 58.

Furnace heater 12 may be a resistive electrical heater that receives electrical power from a power supply by wires 32 electrically connected to electrodes 24. The first and second conductive leads 14, 16 may have a non-negligible electrical resistance, and are therefore represented as resistors in the schematic view of FIG. 1. However, heater elements 50, 52 may have a significantly higher resistance as compared to leads 14, 16 to generate heat within furnace chamber 112. Thus, heater elements 50, 52 may be helical resistive heater elements that form a resistive body electrically connected to first and second conductive leads 14, 16. Heater elements 50, 52 may be the primary source of heat generated by heater 12. Alternatively, conductive leads 14, 16 may have a low or negligible resistance, particularly in comparison to heater elements 50, 52.

Electrodes 24, (which may be formed by or fixed to proximal ends of leads 14, 16) first and second conductive leads 14, 16, and first and second heater elements 50, 52 may be electrically connected to each other. Furnace heater 12 may form a circuit when electrodes 24 are connected to a power supply, e.g., via wires 32. First and second conductive leads 14, 16 may therefore have sufficient electrical conductivity for conducting electrical power to heater elements 50, 52. While a relatively high electrical conductivity may be beneficial in leads 14, 16, in at least some materials, such an electrical conductivity may be associated with a relatively higher thermal conductivity. In some applications, it may be desirable to include leads 14, 16 with a low thermal conductivity. Thus, heat transmission and electrical conductivity may be balanced to achieve desirable performance of conductive leads 14, 16 such that a sufficient electrical conduction and a thermal conductivity is provided. For example, by providing leads 14, 16 with an appropriately low thermal conductivity, leakage of heat from hot zone 126 may be limited.

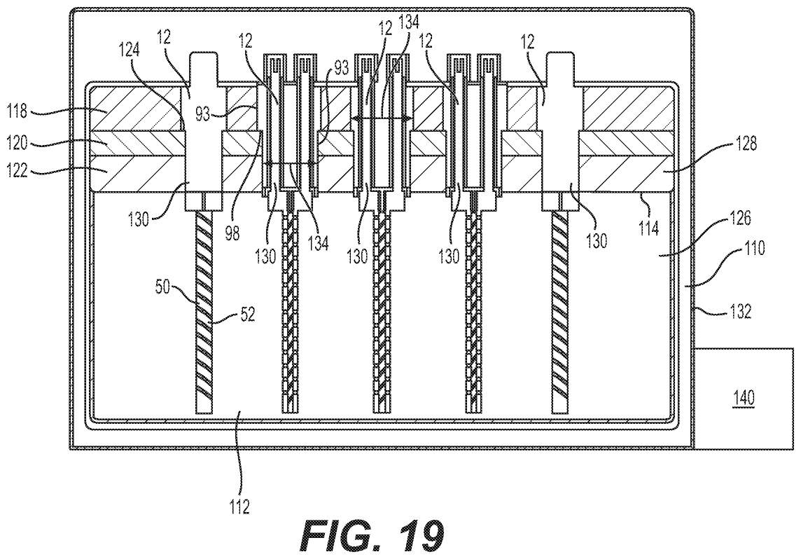

As shown in FIG. 19, for example, heater 12 may be incorporated as part of a vacuum chamber or furnace chamber 112 of a furnace 110. Furnace 110 may include one or more insulation layers 118, 120, 122 through which heater 12 extends. Insulation layers 118, 120, 122 may form a portion of an insulation pack that surrounds hot zone 126 of furnace chamber 112 within which heat is generated by one or more heaters 12. Furnace 110 may be a vacuum furnace configured to apply a vacuum pressure to at least furnace chamber 112 via one or more vacuum pump(s) 140 (FIG. 19). For example, furnace 110 may be configured to generate vacuum pressures of less than 1 Torr, less than 0.1 Torr, less than 0.01 Torr, and/or less than 0.001 Torr. Moreover, furnace 110 may be configured to generate vacuum pressures ranging from 1 to 0.1 Torr, 0.1 to 0.01 Torr, and/or 0.01 to 0.001 Torr. The furnace chamber 112 may form a hot zone 126 that is enclosed by one or more layers of thermal insulation, including thermal insulation layers 118, 120, 122 at an upper end of chamber 112. The distal-most surface of insulation 122 may define a hot face 114 that surrounds a relatively hot zone 126. An area immediately above hot face 114 of insulation 122 may form a relatively cold face 128 (e.g., a face formed by insulation 118, 120, and/or 122, which may have a temperature significantly lower than hot zone 126. Furnace heater 12 may extend through both cold face 128 and hot zone 126. Heater elements 50, 52 may be positioned within, e.g., entirely within, hot zone 126, while conductive leads 14, 16 may be positioned within, e.g., entirely within, cold face 128. Alternatively, leads 14, 16 may extend from cold face 128 to hot zone 126.

FIG. 2 is a perspective view illustrating the heater elements 50 and 52 of heater 12. Heater elements 50, 52 may each have a helical shape that extends from a proximal region 54 to a distal region 56. The respective distal regions 56 may be joined at base 58 or may be joined at an inflection point at the respective distal regions 56. Heater elements 50, 52 may form a pair of interleaved or interwoven legs joined only at distal ends 56. As shown in FIG. 2, these two heater elements 50, 52 may be spaced apart from each other throughout their length, with the exception of base 58, so as to form a double helix. Forming heater elements 50, 52 as a double helix may impart spring-like qualities, such as resiliency and flexibility, even when heater elements 50, 52 are formed of a hard material, such as silicon carbide. For example, FIG. 2 shows heater elements 50, 52 in a configuration in which a force is applied at proximal ends 54 to separate the two heater elements 50, 52 in a direction orthogonal to a proximal-distal or longitudinal direction e.g., to splay the two heater elements 50, 52 apart from one another, as indicated by the pair of opposed arrows. Helical resistive heater elements 50, 52 may exhibit high (electrical) resistance for a given size (such as length, width, diameter, thickness of heating material, etc.), due at least in part to their helical configuration, which may increase an effective length of each heater element 50, 52. This helical shape may provide a reduced cross-sectional area of a current flow path through heater elements 50, 52, which may also assist in providing a sufficient resistance. Additionally, helical resistive heater elements 50, 52 may provide improved robustness with respect to thermal shock and thermal cycling due, at least in part, to the flexibility imparted by the double-helical shape of heater elements 50, 52. For example, helical resistive heater elements 50, 52 may experience a reduced incidence of failure and/or cracking during start-up, shut-down, or operation.

Helical resistive heater elements 50, 52 may be formed by shaping silicon carbide into a helix that is subsequently sintered. In one aspect, a helix may be produced by machining a tube or cylinder of silicon carbide, in a green (unsintered) state, and subsequently sintering the machined helix. Each heater element 50, 52 may be provided with a predetermined resistance for a desired application. This resistance, as well as desired mechanical properties, may be achieved by varying the composition and/or shape of the heater elements 50, 52. Exemplary resistances may include approximately 5, 6, 7, 8, 9, 10, 11, 12, 13, 14, or 15 ohms. Heater elements 50, 52 may be formed of any suitable resistive material, and may include silicon carbide. Suitable forms of silicon carbide may include recrystallized silicon carbide (such as high-density recrystallized silicon carbide), low-density silicon carbide, and high-porosity silicon carbide, for example. Reaction-bonded silicon carbide may be particularly suitable due to its resistance to attack by silicon monoxide. Reaction-bonded silicon carbide may have a low-porosity, high-density, and an excess of Si within the material. In one aspect, reaction-bonded silicon carbide may be appropriate for use in a vacuum furnace.

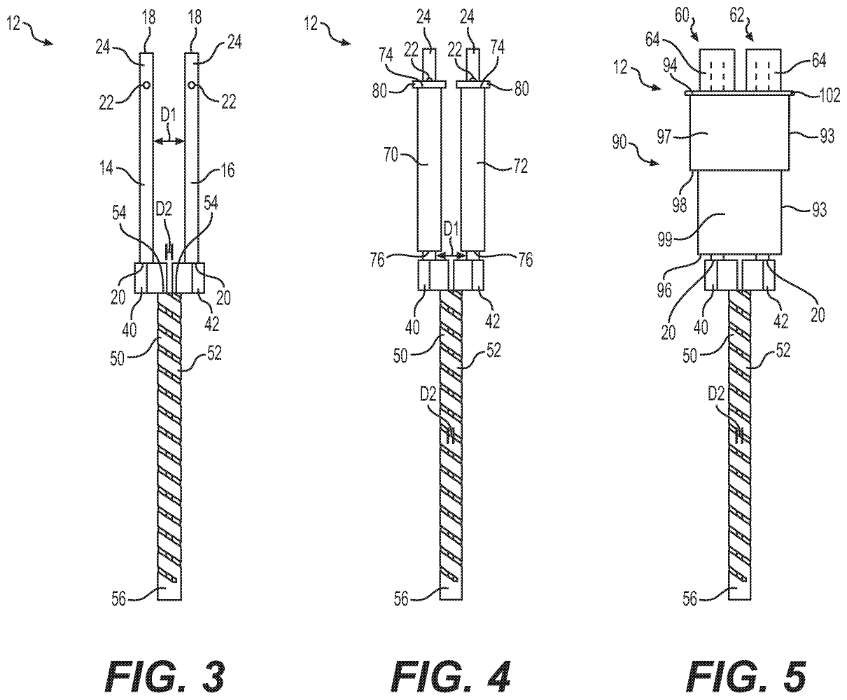

FIGS. 3-5 are front views of heater 12 illustrating various features which may be included in heater 12. FIG. 3 illustrates heater 12 with a pair of spaced-apart leads 14, 16. FIG. 4 shows heater 12 with a pair of electrical insulators 70, 72 positioned to at least partially surround leads 14, 16. FIG. 5 shows heater 12 with a plug casing or housing 90 positioned around at least a portion of first and second electrical insulators 70, 72 and leads 14, 16. FIG. 5 also shows first and second potted heads or ends 60, 62 positioned around proximal ends 18 of leads 14, 16.

With reference to FIG. 3, heater 12 may include a pair of conductive leads 14, 16 that each extend from cold or proximal ends 18 to hot or distal ends 20. Leads 14, 16 may extend substantially parallel with respect to each other along a proximal-distal (longitudinal) direction of heater 12 (downward in FIGS. 3-5). Leads 14, 16 may be spaced apart by a distance Dl. In the exemplary configuration shown in FIGS. 3-5, distance D1 may be approximately constant across an entire length of conductive leads 14, 16. Alternatively, distance D1 may change along the length of leads 14, 16. Distance D1 may be measured in a direction orthogonal to the proximal-distal direction of heater 12.

In one aspect, conductive leads 14, 16, including electrodes 24 on proximal ends thereof, may include silicon carbide rods having a length of two inches or more. Leads 14, 16 may be doped so as to provide suitable electrical conductivity and may be formed in any suitable shape (cylindrical, rectangular, polygonal, etc.). Distal ends 20 of leads 14, 16 may be connected to first and second transitions 40, 42. These transitions 40, 42 may act as connectors or bridges that mechanically and electrically connect leads 14, 16 and heater elements 50, 52, respectively. In one aspect, transitions 40, 42 may be formed partially or entirely of silicon carbide, and may be doped for sufficient electrical conductivity. Transitions 40, 42 may form portions of heater 12 with a lower electrical resistance (e.g., as measured per unit length), and may generate less heat as compared to heater elements 50, 52 and/or leads 14, 16. Transitions 40, 42 may be sintered to leads 14, 16 and/or to heater elements 50, 52. Transitions 40, 42 may form an abrupt transition between heater elements 50, 52 and leads 14, 16, (e.g., characterized by right angles) or may provide a relatively gradual transition including one or more curved surfaces. Transitions 40, 42 may act as spacers between heater elements 50, 52 and leads 14, 16. Additionally, transitions 40, 42 may provide connection points for leads 14, 16 that define distance Dl. While leads 14, 16 may be connected to proximal ends of transitions 40, 42, distance D1 may be increased by connecting leads 14, 16 to outer side surface of the respective transitions 40, 42, which may act as spacer elements.

Heater elements 50, 52 may be connected to transitions 40, 42 at the respective proximal ends 54 of heater elements 50, 52. Heater elements 50, 52 may be spaced apart from each other by a distance D2, except at distal ends 56. Distance D2 may be approximately constant along the length of heaters 50, 52, and may be measured in a direction perpendicular to the proximal-distal direction of heater 12. In one aspect, distance D1 may be at least twice as large as distance D2. If desired, distance D1 may be at least three times as large as distance D2, or more. As noted above, distance D1 may vary along a length of leads 14, 16. When distance D1 is variable, distance D1 may be the smallest (shortest) distance between leads 14, 16. In such a configuration, this distance D1 may be at least two times as large as distance D2, at least three times as large as distance D2, or larger. By providing a distance D1 that is at least twice distance D2, it may be possible to provide a separation between leads 14, 16 that avoids shorting. For example, such a distance may provide a sufficiently long path length between the leads 14 and 16, such that shorting is fully suppressed, even when a high voltage is applied to heater 12. In one aspect, it may be possible to increase a spacing between the leads 14, 16 at cold end or within cold face 128, while avoiding the need to increase the spacing between heater elements 50, 52 at a hot end of heater 12 within hot zone 126.

FIG. 4 illustrates heater 12 with a pair of electrical insulators 70, 72 covering at least a portion of leads 14, 16. Electrical insulators 70, 72 may be ceramic insulators, such as a dielectric ceramic. However, insulators 70, 72 may be formed of any suitable electrically-insulating material. These insulators may have any suitable shape (e.g., rectangular, cylindrical, polygonal, etc.) and may surround or encircle a portion or an entirety of a respective lead 14, 16 so as to separate one of the leads from the other of the leads. For example, an outer (circumferential) periphery of a portion of lead 14 may be surrounded by insulator 70. Insulators 70, 72 may extend from respective proximal ends 74 to respective distal ends 76. While a pair of separate insulators 70, 72 may separately surround a respective lead 14, 16, heater 12 may be provided with only a single insulator surrounding a single one of leads 14, 16. Alternatively, a single insulator may be provided so as to surround both leads 14, 16. Such a single insulator may include an insulating wall between leads 14, 16, for example.

In one aspect, insulators 70, 72 may be slidably received on the respective leads 14, 16. Insulators 70, 72 may extend along an entirety of leads 14, 16, or may instead extend along 30%, 40%, 50%, 60%, 70%, 80%, or 90% of a length of one or both leads 14, 16. If desired, insulators 70, 72 may be longer than leads 14, 16. Insulators 70, 72 may be provided, for example, along a portion of leads 14, 16 where deposition and/or shorting may be expected to occur in leads 14, 16, for example where distance D1 is equal to, or less than, distance D2 (if this occurs). Insulators 70, 72 may surround or encircle each portion of leads 14, 16 and may extend beyond an area where deposition and/or shorting may be expected to occur in a heater with closely-spaced leads.

Heater 12, including insulators 70, 72, may be secured in place via one or more holes 22 configured to receive a pin, which may cooperate with a flange. Flanges may be formed on proximal end 74 of each electrical insulator 70, 72, or may be provided separately from insulators 70, 72. In the exemplary configuration shown in FIG. 4, a pin may be inserted through holes 22 and secured against a corresponding flange at proximal end 74 for vertical support of heater 12. Although a flange and pin are described in this embodiment, any suitable securing mechanism may be used. In one aspect, insulators 70, 72 may be inserted through insulation layers 118, 120, and/or 122 and may slidably receive leads 14, 16. Insulators 70, 72 may be fixed in place relative to leads 14, 16, or may be capable of at least some movement relative to leads 14, 16 when secured in place.

FIG. 5 illustrates heater 12 with a plug or housing 90 provided over leads 14, 16 and insulators 70, 72. In one aspect, housing 90 may surround or enclose a proximal end portion of heater 12 and may facilitate installation of the heater 12 into furnace 110, as described below. Potted ends 60, 62 may cover proximal ends 18 of leads 14, 16, e.g., regions of proximal ends 18 that extend proximally beyond housing 90. While housing 90 and potted ends 60, 62 may be provided together on heater 12, as illustrated in FIG. 5, housing 90 may be provided on heater 12 without potted ends 60, 62, for example, housing 90 may also enclose proximal ends 18 of leads 14, 16. Similarly, potted ends 60, 62 may be provided on heater 12 without housing 90.

Plug or housing 90 may be formed of any suitable thermal insulating material configured to be received within furnace 110 (see FIG. 19). Housing 90 may extend from a proximal end 94 adjacent a plate 102 to a distal end 96 adjacent to distal ends 20 of leads 14, 16. Housing 90 may include a rigid thermal insulation having sufficient resistance to cracking. The thermal insulation of housing 90 may be temperature-resistant and may be capable of experiencing repeated thermal cycles from ambient temperatures (approximately 22° C.) to temperatures of about 500° C., 700° C., 1,000° C., 1,200° C., 1,500° C., or higher, without experiencing significant degradation. The thermal insulation of housing 90 may be formed of a dielectric material. The thermal insulation of housing 90 may include one or more of a mineral or a ceramic. For example, the thermal insulation may include a ceramic or an oxide. The thermal insulation may include one or more of a silicate, mullite, alumina, a carbide, or any suitable combinations thereof. Housing 90 may have a higher grade and/or more durable insulation as compared to insulation layers 118, 120, and/or 122 of furnace 110. The thermal insulation of housing 90 may be the same material as one or more of insulation layers 118, 120, 122, and may include additional compounds, such as a ridigizer, to provide the thermal insulation of housing 90 with greater strength and improved resistance to cracking and/or erosion. In some embodiments, the thermal insulating material may also be an electrically insulating material. However, insulators 70, 72 may readily be configured to allow for electrically conductive insulation, such as graphite or molybdenum layers or tungsten layers.

In the exemplary configuration shown in FIG. 5, housing 90 may have a substantially rectangular shape. A proximal portion of housing 90 may have a relatively enlarged or widened (e.g., rectangular) shape forming a relatively widened proximal portion 97. A distal portion of housing 90 may have a reduced shape as compared to relatively widened proximal portion 97 so as to form a narrowed (e.g., rectangular) distal portion 99. A step 98 may form a shoulder or protrusion at a distal end of proximal portion 97. Step 98 may form a distal-facing ledge of housing 90. Although housing 90 is shown with proximal and distal portions 97, 98 with an intermediate step 98, housing 90 may have any suitable shape, such as a rectangular shape, cylindrical or other rounded shape, or a polygonal shape, and may include portions with one or more of these shapes. The outer perimeter of proximal and distal portions 97, 98 of housing 90 may include one or more alignment surfaces 93 to facilitate alignment and retention of heater 12 in furnace 110, as described below. Alignment surfaces 93 may be approximately parallel, or may introduce a taper to facilitate an interference or friction fit with furnace 110. Housing 90 may itself form a proximal portion of heater 12 extending between a proximal (relatively) cold end at proximal end 94 of housing 90, and a proximal (relatively) hot end at distal end 96 of housing 90.

Plate 102 may provide a support structure on the proximal end 94 of housing 90. For example, plate 102 may support one or more potted ends 60, 62 and may prevent the potted ends 60, 62 and wires 32 (and/or electrodes 24) from passing into or though housing 90. Plate 102 may include a pair of through-holes or openings 104 (FIG. 7) that receive leads 14, 16 and/or insulators 70, 72. Plate 102 may be formed of any suitable material, such as mica. In an alternate embodiment where plate 102 is omitted, potted ends 60, 62 may instead be in direct contact with proximal end 94 of housing 90.

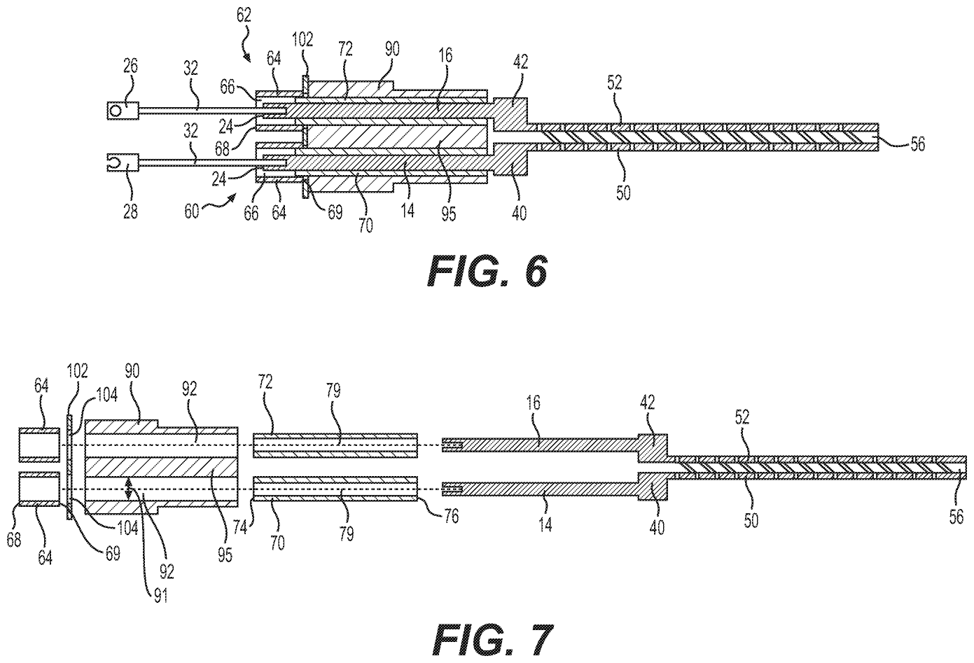

At a proximal end of heater 12, one or more potted ends 60, 62 may separately surround and/or cover a portion of lead 14 and/or lead 16, such as proximal ends 18. Potted ends 60, 62 may include a pair of retainers or caps 64 within which potting material 66 may be provided (FIG. 6). In one aspect, potting material 66 may be placed on a proximal portion of leads 14, 16. In particular, potting material 66 may surround electrode 24. Caps 64 may be hollow tubes or hollow cylinders, rectangles, ovals, etc. (or any other suitable shape) extending from a proximal end 68 to a distal end 69, and may be formed of an electrically-insulating material, such as a ceramic. Any suitable potting material 66 may be provided within caps 64, such as an oven-curable ceramic (e.g., mullite or alumina). While two potted ends 60, 62 are provided separately in the exemplary embodiment shown in FIG. 5, a single potted end may surround both leads 14, 16. If a single potted end is employed, such a potted end may surround a portion of both leads 14, 16, and may include an internal wall between leads 14, 16.

An electrical connection to a power supply may be provided by any suitable lead, connector, and/or wiring fixed to leads 14, 16 prior to the curing of potting material 66. Potted ends 60, 62 may protect against surface arcing by increasing a shorting path between leads 14, 16. Potted ends 60, 62 may also form electrical insulation that surrounds a distal end or portion of leads 14, 16 and electrodes 24.

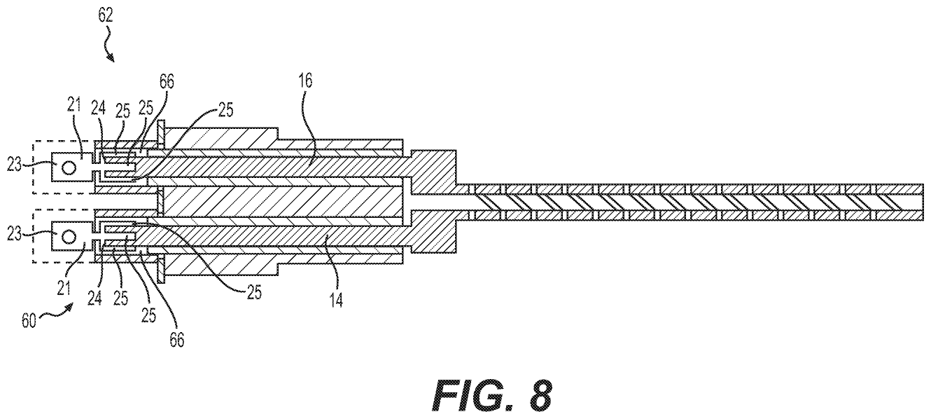

As shown in the cross-sectional view of FIG. 6, a connector such as wire 32 may extend within potting material 66. Wires 32 may be fixed to respective electrodes 24 at proximal end 18 of leads 14, 16. Each wire 32 may be surrounded by a layer of insulation (not shown), except at proximal and distal end regions thereof. Potting material 66, once cured, may fix the respective cap 64, wire 32, and lead 14 or 16 together. In one aspect, potting material 66 may hold the potted ends 60, 62, leads 14, 16, wires 32 (or terminal 21, FIG. 8), and optionally plate 102, together as a unit.

Distal ends of each wire 32 may be provided outside of potted ends 60, 62, and may include a connector 26, 28 for connection to a power supply. One or both of connectors 26, 28 may have a closed-ring configuration, as exemplified by connector 26, or an open-ring configuration, as exemplified by connector 28. Wires 32 may be of any appropriate length, and may have different lengths. While an electrode 24 may be recessed within each cap 64, electrodes 24 (and the distal end of the respective wire 32), may extend outside of caps 64, if desired.

FIG. 7 is an exploded view illustrating exemplary components of heater 12. Heater 12 may be formed by spaced-apart leads 14, 16, transitions 40, 42, and heater elements 50, 52 alone, or may be formed by assembling the integral leads 14, 16, transitions 40, 42, and heater elements 50, 52, with one or more of electrical insulators 70, 72, housing 90, or potted ends 60, 62. For example, insulators 70, 72 may include a through-hole or opening 79 extending from proximal end 74 to distal end 76. Opening 79 may have a diameter that is slightly larger than a diameter of one or both leads 14, 16. Thus, insulators 70, 72 may be positioned relative to leads 14, 16 so as to surround at least a portion of the leads 14, 16. In some aspects, insulators 70, 72 may slidably receive leads 14, 16 respectively. When housing 90 is included as part of heater 12, this housing 90 may be assembled over insulators 70, 72, by sliding housing 90 in a proximal-to-distal direction or by coupling two or more portions e.g., halves, together around insulators 70, 72. Housing 90 may include respective openings 92 for receiving insulators 70, 72 and leads 14, 16. Openings 92 may be separated by an center wall 95 of thermal insulation between insulators 70, 72. Openings 92 may be sized so as to provide sufficient space to accommodate thermal expansion of insulators 70, 72.

Openings 92 may be have a size (as indicated by arrow 91) so as to receive a portion of or an entirety of transitions 40, 42. Alternatively, openings 92 may be sized smaller than transitions 40, 42 at a distal end thereof, to prevent entry of transitions 40, 42 within housing 90 (see FIG. 6) and to limit motion of housing 90 in a distal direction with respect to leads 14, 16. As shown in FIG. 7, each of the pair of openings 92 may be provided separately sized to allow interior surfaces thereof to contact and align with insulators 70, 72. The pair of openings 92 may extend through housing 90 such that openings 92 may be sized so as to allow respective proximal ends 74 of insulators 70, 72 to extend therethrough. Potting material 66 may then be used to affix the insulators 70, 72 to each potted end 60, 62. If desired, after curing, the heater elements 50, 52, transitions 40, 42, and leads 14, 16 may be slidable within housing 90, but not removable from housing 90.

Alternatively, openings 92 may be sized so as to allow housing 90 to be assembled by sliding housing 90 in a distal-to-proximal direction. This may be performed, for example, by not including center wall 95, and by forming a single opening that spans the area occupied by openings 92 and center wall 95 as shown in FIGS. 6 and 7. Such a single opening may extend through both the proximal and distal ends 94, 96 (FIG. 5) of housing 90. In such a configuration, housing 90 may be assembled on heater 12 after the assembly of insulators 70, 72, plate 102, and potted ends 60, 62. If desired, when a single opening is formed in housing 90, the opening may be sized to allow heater elements 50, 52, transitions 40, 42, and leads 14, 16 to pass through the hosing 90, while preventing potted ends 60, 62 from passing through the housing 90.

FIG. 8 illustrates an exemplary configuration of heater 12 in which terminals 21 are provided on electrodes 24. Each terminal 21 may include one or more fingers or legs 25 that contact and press upon a surface of one of leads 14, 16. Terminal 21 may include a head 23 that extends outside of potted ends 60, 62, while legs 25 may be embedded within potting material 66. Terminals 21, and/or electrodes 24, may be surrounded by potting material 66. Terminals 21 may be fixed to each electrode 24 by any suitable method. In an exemplary configuration, terminals 21 may be secured by thermal spraying (e.g., flame spraying) at least a portion of legs 25 of terminals 21 to a portion of leads 14, 16. For example, terminals 21 may be secured via flame-sprayed nickel or flame-sprayed aluminum.

In the exemplary configuration illustrated in FIG. 8, each terminal head 23 may protrude proximally with respect to each potted end 60, 62. Alternatively, each terminal head 23 may be provided within potted ends 60, 62. For example, potted ends 60, 62 may be provided with an increased length, as shown in dashed lines in FIG. 8. In such a configuration, suitable wires (e.g., wires 32), may be connected to each terminal head 23 before potting material 66 is applied and cured within such elongated potted ends.

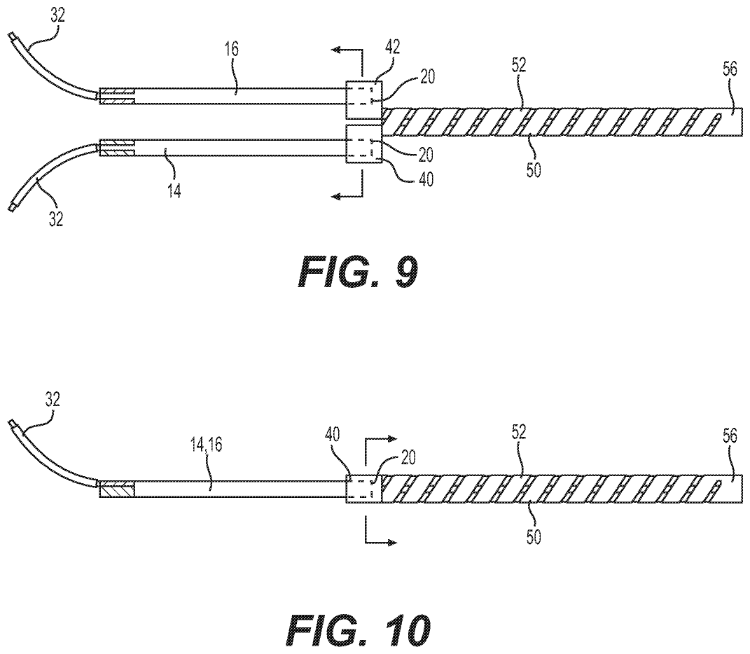

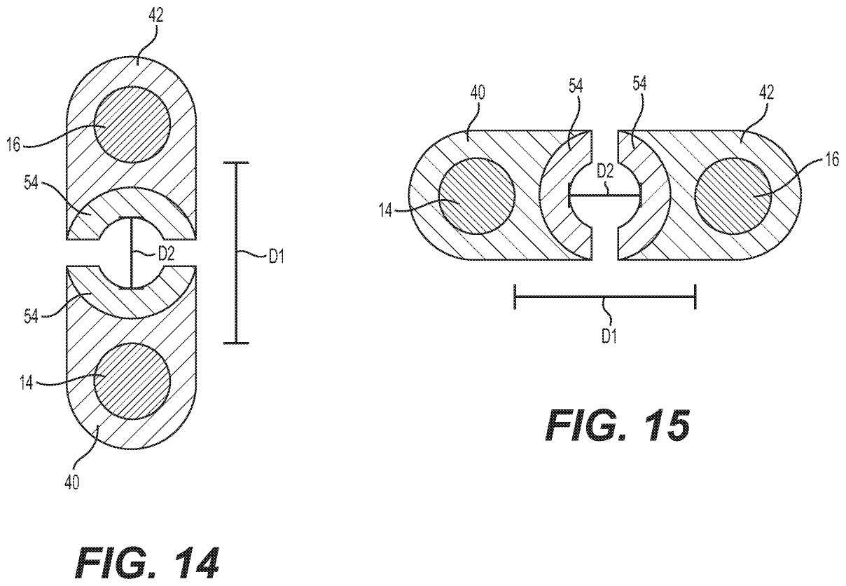

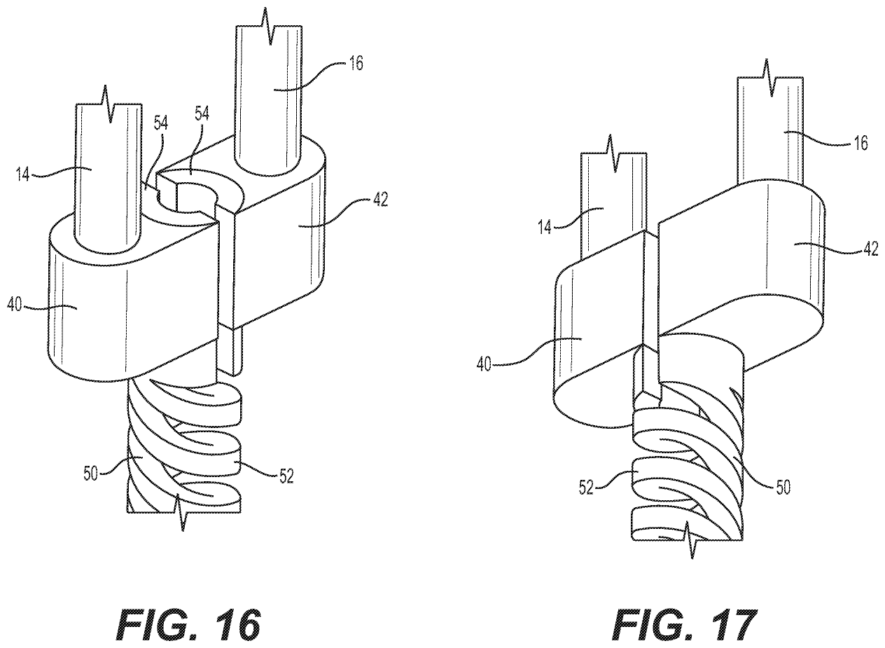

FIGS. 9-17 illustrate various aspects of heater 12. Heater elements 50, 52 of heater 12 may form a so-called “hot end” of an assembled heater 12 and, upon being energized, may glow brightly and heat a furnace. In one aspect, the resistivity of a heating element formed by connected spiral or helical resistive heater elements 50, 52 may be known. Transitions 40, 42 may form a bridge member having a pair of sides (each side formed by one of transitions 40, 42) that are secured to respective C-shaped ends formed by proximal ends 54 of heater elements 50, 52 as best shown in FIGS. 14-16. Such a bridge member, formed by transitions 40, 42, may have a known electrical resistance that is less than the respective electrical resistance of heater elements 50, 52, such that electrical current may pass through transitions 40, 42 with an appropriate level of heat generation, e.g., minimal heating of the bridge member.

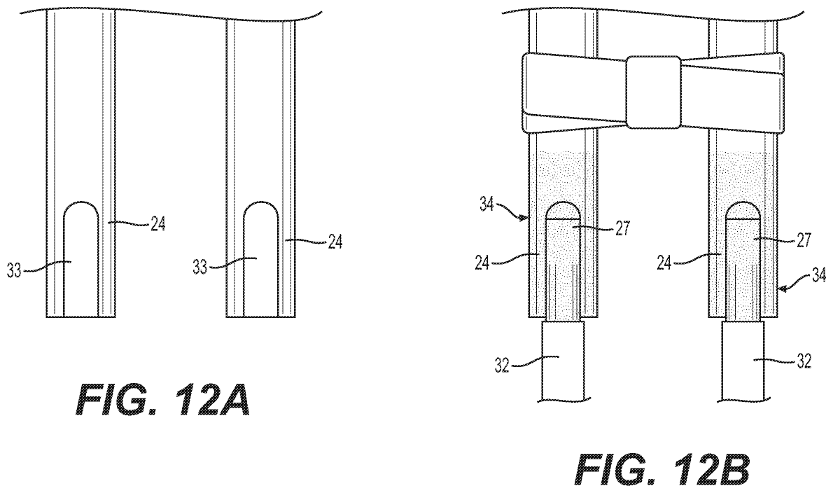

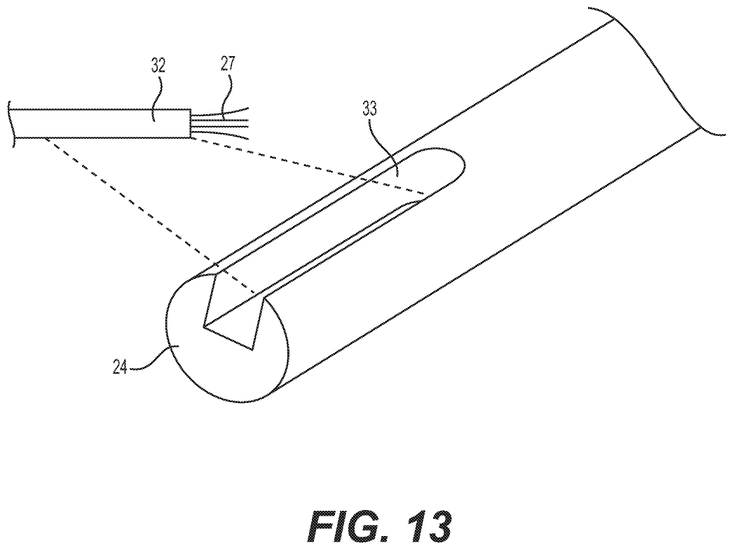

Leads 14, 16 may be secured to transitions 40, 42 by monolithic molding at off-set locations of the transitions 40, 42, as shown in FIG. 9 for example. Opposite ends of leads 14, 16 may be formed with receiving grooves or channels 33 (best shown in FIGS. 12A, 12B, and 13), which may form a receiving geometry that includes a hollow end (not shown), or a receiving-profile geometry (not shown), that may be formed into and within the monolithic structure of each of leads 14, 16. In addition to a hollow end or receiving-profile geometry, with reference to FIG. 13, each lead 14, 16 may include a trench or groove formed by channels 33. The bridge assembly may be assembled in a green state such that the parts may sinter-bond during sintering.

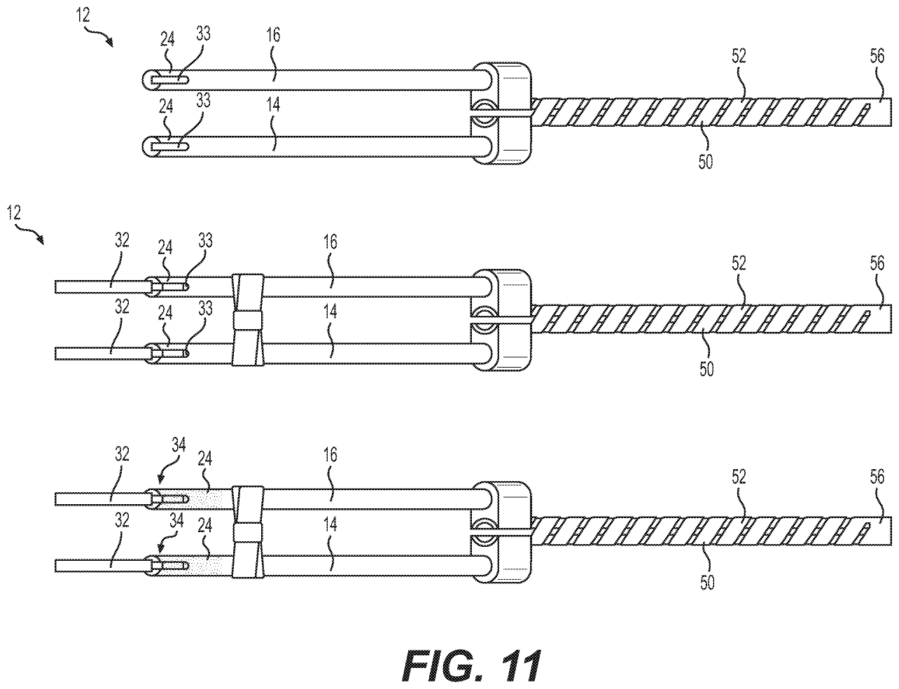

In one aspect, wires 32 may include an electrical connector, such as a twisted or braided wire. Wires 32 may include one or more metallic wires of any suitable size (e.g., 10 gauge or any other suitable gauge). Wires 32 may include an exposed (e.g., braided) wire end 27 of exposed metal (e.g., Ni coated Cu wires, or any other suitable alloy wire usable within a hot oxidizing atmosphere). Wire end 27 may be secured by, for example, chemical metalized spray bonding for electrical conduction with leads 14, 16. For example, assembly may be performed, e.g., by placing wire end 27 within groove 33, or within a hollow end or receiving-profile geometry, and performing spray bonding to distribute flame-spray or spray bonding material 34 on electrodes 24 and wire ends 27. Upon positioning wire ends 27 within, e.g., groove 33, the wire ends 27 may be secured on position by a metalized spray bonding to fully cover and fully enmesh leads 14, 16 and wires 32 with spray-bonding material 34, as shown in FIGS. 11 and 12B, forming a monolithic continuous electrical connection from a first wire 32, through transition 40, through heater elements 50, 52, and back through the transition 42, to lead 16 and a second wire 32. The electrical resistance of wires 32 may be less than that of transitions 40, 42, so that transmitted power causes little to no internal heating in wires 32, and so the wires 32 (which may be provided in the cold-side outside of a furnace) experience little or no degradation.

Terminal ends of leads 14, 16 (see, e.g., proximal ends 18 of FIG. 3, and/or electrodes 24 of FIGS. 6 and 9-13) may be solid or hollow in formation, and may be from about 0.25 in. in outer diameter to about 0.75 in. in outer diameter. However, there is no limit to the size of leads 14, 16, and the surface of leads 14, 16, may be adjusted to aid in electrical conductivity such that the joined part may sinter bond during sintering.

With reference to FIGS. 14-17, the assembly of transitions 40, 42 and the “bridge” formed by transitions 40, 42 may join each side of a pre-fired “hot zone” section (transitions 40, 42 and heater elements 50, 52) to a pair of pre-fired “cold end” or rods formed by leads 14, 16. The transitions 40, 42 may be electrically conductive and of sufficiently refractory quality to withstand the high temperature produced by heaters 50, 52 (e.g., at least about 1650° C. or above). The finished transitions 40, 42 may create joints formed primarily with SiC material which has a lower resistivity than SiC heater elements 50, 52 to avoid significant self-heating in the “bridge” section.

The “bridge” section or bridge structures formed by transitions 40, 42, may be joined using a carbonaceous resin paste mixture while all heater 12 components, including transitions 40, 42, may be placed in a position-mold such that the joined part may sinter bond during sintering. Pre-fired SiC ferrules may be placed around each “cold end” (e.g., leads 14, 16) for dimensional spacing, and to provide mechanical support until the resin paste is thermally dried and fully cured. Thereafter, a period of non-thermal setting or green drying may elapse prior to removal of heater 12 from the mold. During subsequent thermal curing, the organic content of the resin paste may largely convert to a carbon body. The cemented heater 12 may then be removed from an assembly fixture and prepared for “siliconizing” or firing at temperatures of at least 1410° C. in an induction furnace, or any other suitable high temperature furnace. During this firing process, the pre-form-carbon body is reacted with silicon (Si) metal located nearby (in the area and same region) to create “bridge” bodies between SiC grains which are primarily composed of SiC with a minor free Si content. As a result of the amount of free-Si (free silicone) content and the easy electrical conductivity through free-Si, the transitions 40, 42 may easily transmit electricity to heater elements 50, 52 without significant thermal degradation.

In an alternative aspect, pre-forms composed of Carbon and SiC powders may be dry-pressed to near-net shapes and then joined to each side of the “hot zone” section.

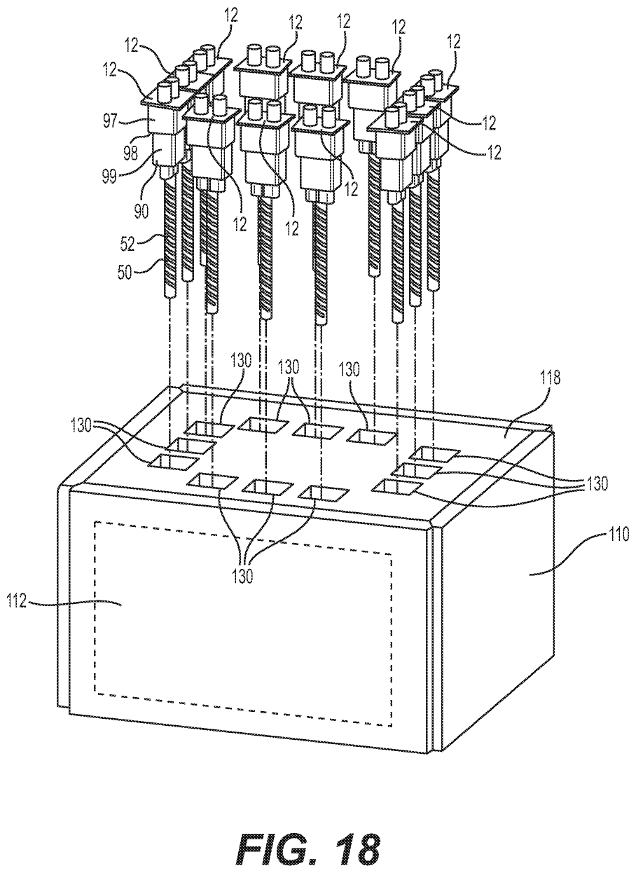

FIG. 18 is an exploded view of an exemplary assembly of heaters 12 and furnace 110 into which heaters may be assembled. Furnace 110 may represent a portion of a vacuum furnace in which a part may be inserted. Additional components of furnace 110 are omitted from FIG. 18 in the interest of clarity. Furnace 110 may form a furnace body, and may be enclosed within a steel housing 132 (FIG. 19). The furnace 110 may be movable and/or separable from another (lower or upper) furnace portion that includes one or more vacuum pumps 140, gas lines, vacuum manifolds, gas manifolds, and any other components useful in operating (including maintaining a vacuum within) furnace 110. A plurality of heaters 12 may be assembled within heater openings 130 of furnace 110 to generate heat in the hot zone 126 of furnace 110. Heater elements 50, 52 of each heater 12 may extend within furnace chamber 112 so as to surround a furnace retort provided therein. A plurality of heater openings 130 may be included to receive a respective plurality of heaters 12. In an exemplary configuration, furnace openings 130 may be provided within (and extend through) an upper insulation layer 118. Insulation layers 118, 120, and/or 122 may provide both thermal and electrical insulation, and may supplement the electrical insulation provided by insulators 70, 72 to further resist shorts between leads 14 and 16.

Heater openings 130 may be regularly spaced within furnace 110. In one aspect, furnace openings 130 may be spaced at substantially regular intervals around a center of furnace chamber 112. Thus, when one or more parts are provided within furnace chamber 112, heaters 12 may more uniformly heat each part. In one aspect, heater openings 130 may surround a central portion of furnace chamber 112. While heater openings 130 may be aligned in rows of two, three, or more openings 130, openings 130 may instead be staggered at positions within insulation 118, for example. Additionally, openings 130 and heaters 12 may be oriented in the bottom and/or one or more side surfaces of furnace 110, instead of, or in addition to, heaters 12 oriented in the top surface (e.g., through insulation layers 118, 120, and/or 122).

FIG. 19 shows furnace 110 and heaters 12 once each heater 12 is inserted within a respective heater opening 130 extending through a portion of the insulation of furnace 110. While insulation layers 118, 120, 122 may correspond to insulation provided within furnace 110, additional insulation has been reduced in size or omitted for clarity. For example, it is understood that insulation surrounding hot zone 126 may have a thickness approximately equal to that of one or more of layers 118, 120, 122. Heaters 12 and furnace 110 may generate temperatures sufficient for sintering, such as sintering of metals, and may be portable (e.g., configured to fit through doorways of various sizes). The cross-sectional view of FIG. 19 shows front faces of three central heaters 12 and side faces of the two outer heaters 12 on left and right sides of furnace chamber 112. As shown in FIG. 19, furnace 110 may include three upper layers of insulation, such as exemplary layers 118, 120, and 122. However, more or fewer layers may be provided and the layers may have any suitable thickness. Additional layers of insulation may be included along each of the remaining walls of furnace 110, including each side and/or bottom of furnace 110. The heater openings 130 for receiving each heater 12 may extend through an entirety of insulation layers 118, 120, 122. Each layer of insulation 118, 120, 122 may act primarily as thermal insulation, but may also function as an electrical insulator, as described above. Insulation layers 118, 120, 122 may be non-porous (or have a closed-pore structure) such that depositions do not extend from one of leads 14, 16 to the other of leads 14, 16. Alternatively, if insulation layers 118, 120, and/or 122 have a porous or open-pore structure, housing 90 may be provided with a nonporous or closed-pore structure.

In one aspect, housing 132 may surround and enclose furnace chamber 112 in which each of the heaters is provided. One or more vacuum pumps 140 may be configured to achieve and maintain an appropriate level of vacuum in at least furnace chamber 112. While vacuum pump 140 is illustrated as being positioned on a side of furnace 110, vacuum pump 140 may be provided as part of a lower portion of furnace 110 or any suitable location. Housing 132 may include one or more relatively thick metal, e.g., steel, plates configured to resist the pressure difference between the outside and inside of furnace 110. The steel plate of housing 132 may form a shell or vacuum chamber that may be sealed using any known technique.

Heater openings 130 may have any suitable shape, and may have a shape that corresponds to a shape of heater 12 and housing 90. For example, heater openings 130 may have a shape that matches a shape formed by alignment surfaces 93 on one or more portions of housing 90. A width 134 of each heater opening 130 may change along a proximal-to-distal direction. This change in width 134 may correspond to a change in width of heaters 12 (e.g., a width of housing 90). An exemplary first insulation layer, layer 118, may include a first, widened portion of opening 130. Exemplary second and third insulation layers, layers 120 and 122, may include portions of opening 130 that have a narrower width 134 as compared to layer 118. A shoulder 124 may be formed at the intersection of the widened and narrowed portions of opening 130. Shoulder 124 may form a stop configured to contact the step 98 of a housing 90 of heater 12. Interference between shoulder 124 and step 98 may limit a depth to which heater 12 may be inserted within opening 130, and may ensure that heater 12 is located at a desired position within furnace 110. Additionally, alignment surfaces 93 and the inner surface of opening 130 may provide a press fit, interference fit or a friction fit to secure heater 12. For example, alignment surfaces 93 and/or side surfaces of opening 130 may be tapered. Step 98, as well as alignment surfaces 93 of housing 90, may cooperate with shoulder 124 to allow insertion of heater 12 at a predetermined angular alignment. Additionally or alternatively, adhesive may be provided between housing 90 and opening 130 to secure heater 12. In one aspect, by providing vertically-extending openings 130, heater 12 may similarly extend in a vertical direction. Thus, during operation of furnace 110 and heater 12, each heater 12 may be provided with a sufficiently tight and accurate fit while the double helix formed by heater elements 50, 52 is maintained approximately perpendicular to insulation 118, 120, 122.

When a heater is inserted into a heater opening 130, the electrical insulator formed by one or more insulators 70, 72 may extend through an entire thickness of insulation layers 118, 120, and 122. Insulators 70, 72 may extend from the outside (proximal side) of insulation 118, 120, 122 to a location recessed within, adjacent to, or aligned with, hot face 114 within this insulation. If desired, heaters 12 may extend farther into furnace chamber 112, such that insulators 70, 72 extend into the hot zone 126 of furnace 110. Additionally, insulators 70, 72 may be recessed within an outer surface of insulation 118.

Once each heater 12 is installed in furnace 110, heaters 12 may be electrically connected to a power supply to provide power to electrodes 24. An exemplary current path may be established by leads 14, 16, transitions 40, 42, and heater elements 50, 52. Due to the resistance of heater elements 50, 52, a large amount of heat may be generated within furnace chamber 112. Additionally, one or more vacuum pumps 140 may be configured to maintain vacuum within furnace chamber 112, while shorting and discharge activity is avoided by one or more of: the difference between Distances D1 and D2 (e.g., Distance D1 may at least twice D2), one or more potted ends 60, 62, and one or more insulators 70, 72, which may be included within each heater 12 either alone or in combination.

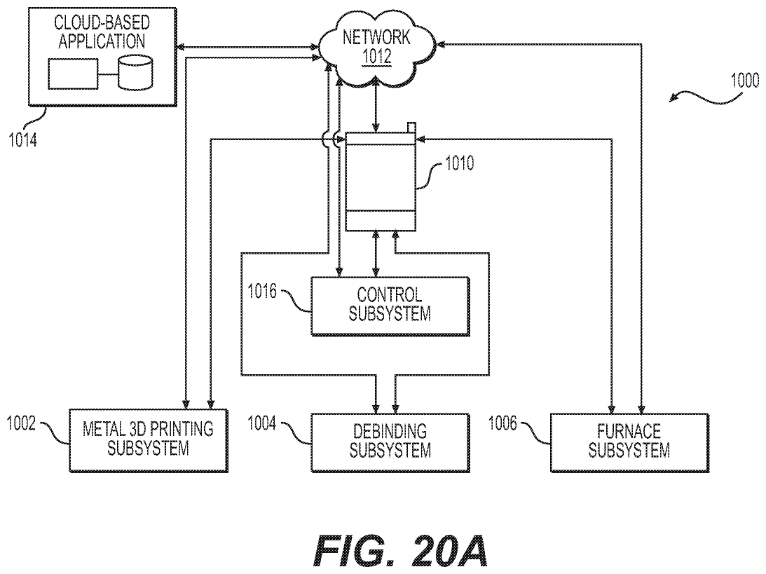

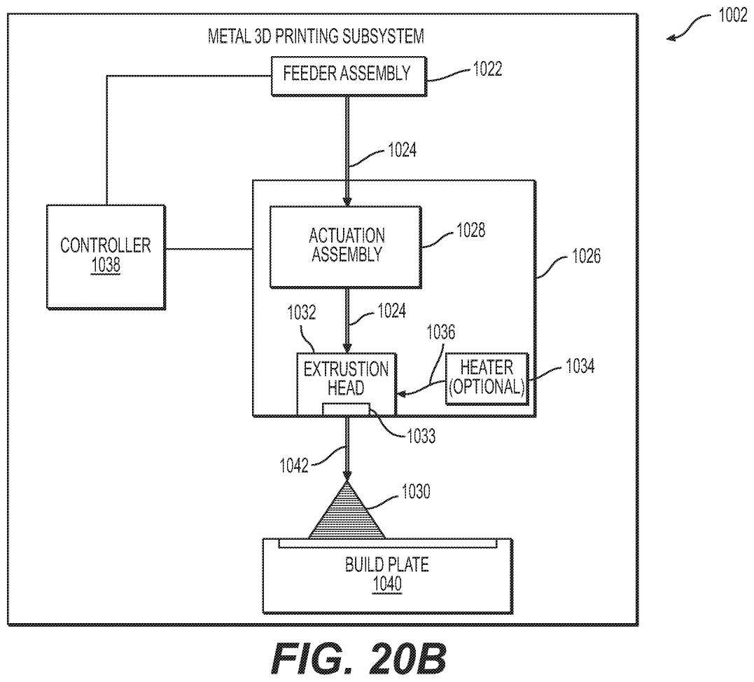

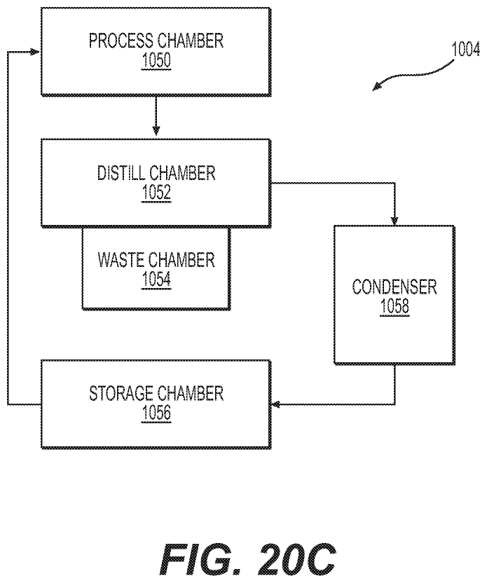

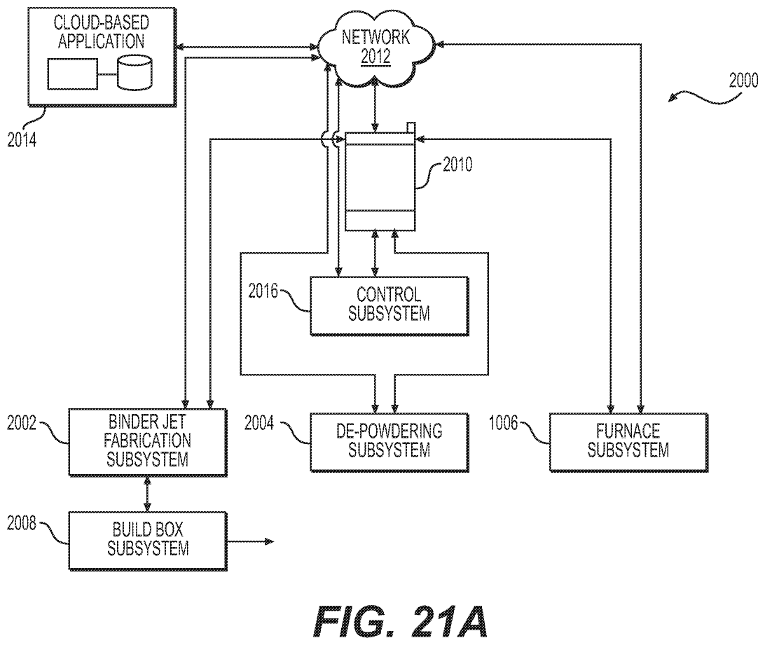

FIG. 20A illustrates an exemplary system 1000 for forming a printed object, according to an embodiment of the present disclosure. System 1000 may include a three-dimensional (3D) printer, for example, a metal 3D printing subsystem 1002, and one or more treatment site(s), for example, a debinding subsystem 1004 and a furnace subsystem 1006, for treating the green part after printing. Metal 3D printing subsystem 1002 may be used to form an object from a build material, for example, by depositing successive layers of the build material onto a build plate. The build material may include metal powder and at least one binder material. In some embodiments, the build material may include a primary binder material (e.g., a wax) and a secondary binder material (e.g., a polymer).

Debinding subsystem 1004 may be configured to treat the printed object by performing a first debinding process, in which the primary binder material may be removed. In some embodiments, the first debinding process may be a chemical debinding process, as will be described in further detail with reference to FIG. 20C. In such embodiments, the primary binder material may dissolve in a debinding fluid while the secondary binder material remains, holding the metal particles in place in their printed form.

In other embodiments, the first debinding process may comprise a thermal debinding process. In such embodiments, the primary binder material may have a vaporization temperature lower than that of the secondary binder material. The debinding subsystem 1004 may be configured to heat the deposited build material to a temperature at or above the vaporization temperature of the primary binder material and below the vaporization temperature of the secondary binder material such that the primary binder material is removed from the printed part. In alternative embodiments, the furnace subsystem 1006 rather than a separate heating debinding subsystem 1004 may be configured to perform the first debinding process. For example, the furnace subsystem 1006 may be configured to heat the deposited build material to a sintering temperature at or above the vaporization temperature of the primary binder material and below the vaporization temperature of the secondary binder material such that the primary binder material is removed from the deposited build material. Heat may be generated by one or more heaters 12 included within furnace subsystem 1006.

Furnace subsystem 1006 may be configured to treat the printed object by performing a secondary thermal debinding process (or also a primary debinding process, as in the alternative embodiment described above), in which the secondary binder material or any remaining primary binder material may be vaporized and removed from the printed part. In some embodiments, the secondary debinding process may comprise a thermal debinding process, in which the furnace subsystem 1006 may be configured to heat the part to a temperature at or above the vaporization temperature of the secondary binder material to remove the secondary binder material. The furnace subsystem 1006 may then heat the part to a temperature just below the melting point of the metal powder to sinter the metal powder and to densify the metal powder into a solid metal part.

As shown in FIG. 20A, system 1000 may also include a user interface 1010, which may be operatively coupled to one or more components, for example, to metal 3D printing subsystem 1002, debinding subsystem 1004, and furnace subsystem 1006, etc. In some embodiments, user interface 1010 may be a remote device (e.g., a computer, a tablet, a smartphone, a laptop, etc.) or an interface incorporated into system 1000, e.g., on one or more of the components. User interface 1010 may be wired or wirelessly connected to one or more of metal 3D printing subsystem 1002, debinding subsystem 1004, or furnace subsystem 1006. System 1000 may also include a control subsystem 1016, which may be included in user interface 1010, or may be a separate element.

Metal 3D printing subsystem 1002, debinding subsystem 1004, furnace subsystem 1006, user interface 1010, or control subsystem 1016 may each be connected to the other components of system 1000 directly or via a network 1012. Network 1012 may include the Internet and may provide communication through one or more computers, servers, or handheld mobile devices, including the various components of system 1000. For example, network 1012 may provide a data transfer connection between the various components, permitting transfer of data including, e.g., part geometries, printing material, one or more support or support interface details, printing instructions, binder materials, heating or sintering times and temperatures, etc., for one or more parts or one or more parts to be printed.

Moreover, network 1012 may be connected to a cloud-based application 1014, which may also provide a data transfer connection between the various components and cloud-based application 1014 in order to provide a data transfer connection, as discussed above. Cloud-based application 1014 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage or processing device within or operably coupled to one or more of metal 3D printing subsystem 1002, debinding subsystem 1004, sintering furnace subsystem 1006, user interface 1010, or control subsystem 1016. In this aspect, metal 3D printing subsystem 1002, debinding subsystem 1004, furnace subsystem 1006, user interface 1010, or control subsystem 1016 may be disconnected from the Internet or other networks, which may increase security protections for the components of system 1000. In either aspect, an additional controller (not shown) may be associated with one or more of metal 3D printing subsystem 1002, debinding subsystem 1004, and furnace subsystem 1006, etc., and may be configured to receive instructions to form the printed object and to instruct one or more components of system 1000 to form the printed object.

FIG. 20B is a block diagram of a metal 3D printing subsystem 1002 according to one embodiment. The metal 3D printing subsystem 1002 may extrude build material 1024 to form a three-dimensional part. As described above, the build material may include a mixture of metal powder and binder material. For example, the build material may include any combination of metal powder, plastics, wax, ceramics, polymers, among others. In some embodiments, the build material 1024 may come in the form of a rod comprising a predetermined composition of metal powder and one or more binder components (e.g., a primary and a secondary binder).

Metal 3D printing subsystem 1002 may include an extrusion assembly 1026 comprising an extrusion head 1032. Metal 3D printing subsystem 1002 may include an actuation assembly 1028 configured to propel the build material 1024 into the extrusion head 1032. For example, the actuation assembly 1028 may be configured to propel the build material 1024 in a rod form into the extrusion head 1032. In some embodiments, the build material 1024 may be continuously provided from the feeder assembly 1022 to the actuation assembly 1028, which in turn propels the build material 1024 into the extrusion head 1032. In some embodiments, the actuation assembly 1028 may employ a linear actuation to continuously grip or push the build material 1024 from the feeder assembly 1022 towards the extrusion head 1032.

In some embodiments, the metal 3D printing subsystem 1002 includes a heater 1034 configured to generate heat 1036 such that the build material 1024 propelled into the extrusion head 1032 may be heated to a workable state. In some embodiments, the heated build material 1024 may be extruded through a nozzle 1033 to extrude workable build material 1042 onto a build plate 1040. It is understood that the heater 1034 is an exemplary device for generating heat 1036, and that heat 1036 may be generated in any suitable way, e.g., via friction of the build material 1024 interacting with the extrusion assembly 1026, in alternative embodiments. While there is one nozzle 1033 shown in FIG. 20B, it is understood that the extrusion assembly 1026 may comprise more than one nozzle in other embodiments. In some embodiments, the metal 3D printing subsystem 1002 may include another extrusion assembly (not shown in FIG. 20B) configured to extrude a non-sintering ceramic material onto the build plate 1040.

In some embodiments, the metal 3D printing subsystem 1002 comprises a controller 1038. The controller 1038 may be configured to position the nozzle 1033 along an extrusion path relative to the build plate 1040 such that the workable build material is deposited on the build plate 1040 to fabricate a three dimensional printed object 1030. The controller 1038 may be configured to manage operation of the metal 3D printing subsystem 1002 to fabricate the printed object 1030 according to a three-dimensional model. In some embodiments, the controller 1038 may be remote or local to the metallic printing subsystem 1002. The controller 1038 may be a centralized or distributed system. In some embodiments, the controller 1038 may be configured to control a feeder assembly 1022 to dispense the build material 1024. In some embodiments, the controller 1038 may be configured to control the extrusion assembly 1026, e.g., the actuation assembly 1028, the heater 1034, the extrusion head 1032, or the nozzle 1033. In some embodiments, the controller 1038 may be included in the control subsystem 1016.

FIG. 20C depicts a block diagram of a debinder subsystem 1004 for debinding a printed object 1030 according to one embodiment. The debinder subsystem 1004 may include a process chamber 1050, into which the printed object 1030 may be inserted for a first debinding process. In some embodiments, the first debinding process may be a chemical debinding process. In such embodiments, the debinder subsystem 1004 may include a storage chamber 1056 to store a volume of debinding fluid, e.g., a solvent, for use in the first debinding process. The storage chamber 1056 may comprise a port which may be used to fill, refill, or drain the storage chamber 1056 with the debinding fluid. In some embodiments, the storage chamber 1056 may be removably attached to the debinder subsystem 1004. In such embodiments, the storage chamber 1056 may be removed and replaced with a replacement storage chamber (not shown in FIG. 20C) to replenish the debinding fluid in the debinding subsystem 1004. In some embodiments, the storage chamber 1056 may be removed, refilled with debinding fluid, and reattached to the debinding subsystem 1004.

The debinding fluid contained in the storage chamber 1056 may be directed to the process chamber 1050 containing the inserted printed object 1030. In some embodiments, the build material that the printed object 1030 is formed of may include a primary binder material and a secondary binder material. In some embodiments, the printed object 1030 in the process chamber 1050 may be submerged in the debinding fluid for a predetermined period of time. In such embodiments, the primary binder material may dissolve in the debinding fluid while the secondary binder material stays intact.

In some embodiments, the debinding fluid containing the dissolved primary binder material (hereinafter referred to as “used debinding fluid”) may be directed to a distill chamber 1052. For example, after the first debinding process, the process chamber 1050 may be drained of the used debinding fluid, and the used debinding fluid may be directed to the distill chamber 1052. In some embodiments, the distill chamber 1052 may be configured to distill the used debinding fluid. In some embodiments, the debinding subsystem 1004 may further include a waste chamber 1054 fluidly coupled to the distill chamber 1052. In such embodiments, the waste chamber may collect waste accumulated in the distill chamber 1052 as a result of the distillation. In some embodiments, the waste chamber 1054 may be removably attached to the debinding subsystem 104 such that the waste chamber 1054 may be removed and replaced after a number of distillation cycles. In some embodiments, the debinding subsystem 1004 may include a condenser 1058 configured to condense vaporized used debinding fluid from the distill chamber 1052 and return the debinding fluid back to the storage chamber 1056.

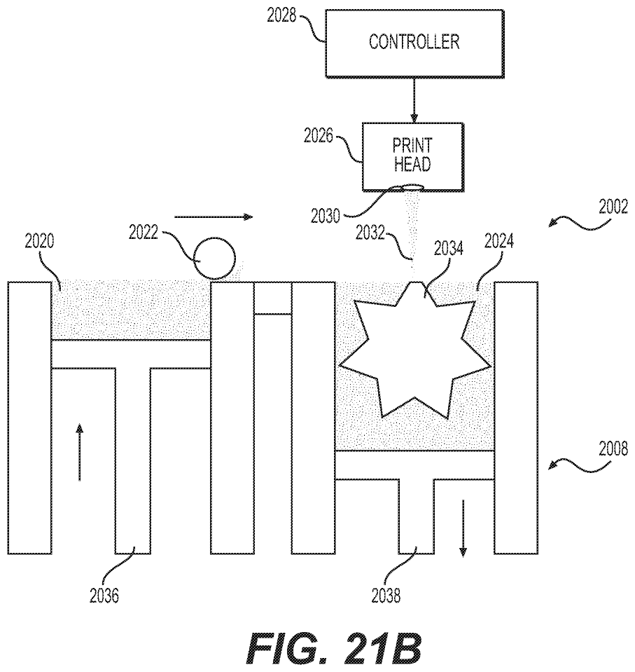

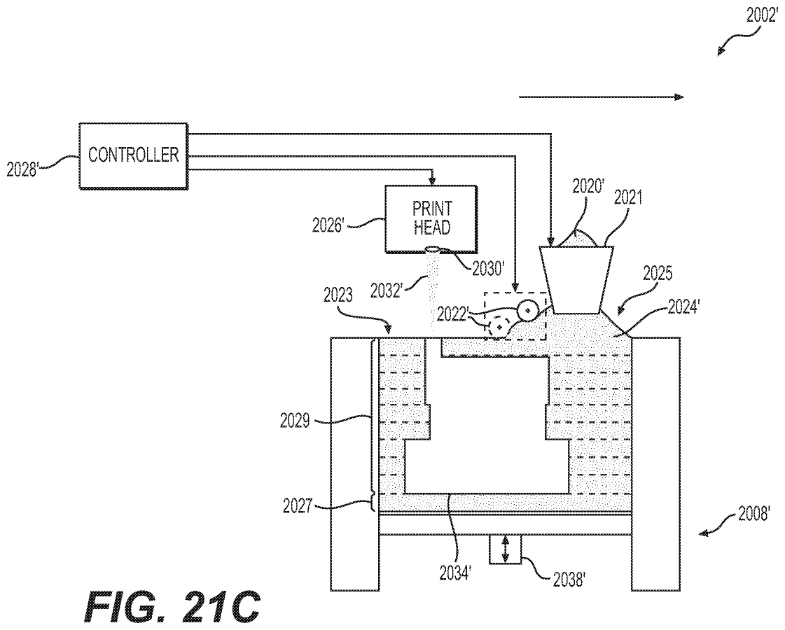

FIG. 21A illustrates another exemplary system 2000 for forming a printed object, according to an embodiment of the present disclosure. System 2000 may include a printer, for example, a binder jet fabrication subsystem 2002, and a treatment site(s), for example, a de-powdering subsystem 2004 and the furnace subsystem 1006 as described with reference to FIG. 20A. Binder jet fabrication subsystem 2002 may be used to form an object from a build material, for example, by delivering successive layers of build material and binder material to a build plate. As shown in FIG. 21A, a build box subsystem 2008 may be movable and may be selectively positioned in one or more of binder jet fabrication subsystem 2002, de-powdering subsystem 2004, and furnace subsystem 1006. For example, build box subsystem 2008 may be coupled or couplable to a movable assembly. Alternatively, a conveyor (not shown) may help transport the object between portions of system 2000.

The build material may be a bulk metallic powder delivered and spread in successive layers. The binder material may be, for example, a polymeric liquid that may be deposited onto and may be absorbed into layers of the build material. One or more of binder jet fabrication subsystem 2002, de-powdering subsystem 2004, and furnace subsystem 1006 may include a shaping station to shape the printed object and a debinding station to treat the printed object to remove a binder material from the build material. Furnace subsystem 1006 may heat or sinter the build material of the printed object. System 2000 may also include a user interface 2010, which may be operatively coupled to one or more components, for example, to binder jet fabrication subsystem 2002, de-powdering subsystem 2004, and furnace subsystem 1006, etc. In some embodiments, user interface 2010 may be a remote device (e.g., a computer, a tablet, a smartphone, a laptop, etc.). User interface 2010 may be wired or wirelessly connected to one or more of binder jet fabrication subsystem 2002, de-powdering subsystem 2004, and furnace subsystem 1006. System 2000 may also include a control subsystem 2016, which may be included in user interface 2010, or may be a separate element.

Binder jet fabrication subsystem 2002, de-powdering subsystem 2004, furnace subsystem 1006, user interface 2010, or control subsystem 2016 may each be connected to the other components of system 2000 directly or via a network 2012. Network 2012 may include the Internet and may provide communication through one or more computers, servers, or handheld mobile devices, including the various components of system 2000. For example, network 2012 may provide a data transfer connection between the various components, permitting transfer of data including, e.g., geometries, the printing material, one or more support or support interface details, binder materials, heating or sintering times and temperatures, etc., for one or more parts or one or more parts to be printed.

Moreover, network 2012 may be connected to a cloud-based application 2014, which may also provide a data transfer connection between the various components and cloud-based application 2014 in order to provide a data transfer connection, as discussed above. Cloud-based application 2014 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage or processing device within or operably coupled to one or more of binder jet fabrication subsystem 2002, de-powdering subsystem 2004, furnace subsystem 1006, user interface 2010, or control subsystem 2016. In this aspect, binder jet fabrication subsystem 2002, de-powdering subsystem 2004, furnace subsystem 1006, user interface 2010, or control subsystem 2016 may be disconnected from the Internet or other networks, which may increase security protections for the components of system 2000. In either aspect, an additional controller (not shown) may be associated with one or more of binder jet fabrication subsystem 2002, de-powdering subsystem 2004, and furnace subsystem 1006, etc., and may be configured to receive instructions to form the printed object and to instruct one or more components of system 2000 to form the printed object.

FIG. 21B illustrates an exemplary binder jet fabrication subsystem 2002 operating in conjunction with build box subsystem 2008. Binder jet fabrication subsystem 2002 may include a powder supply 2020, a spreader 2022 (e.g., a roller) configured to be movable across powder bed 2024 of build box subsystem 2008, a print head 2026 movable across powder bed 2024, and a controller 2028 in electrical communication (e.g., wireless, wired, Bluetooth, etc.) with print head 2026. Powder bed 2024 may comprise powder particles, for example, micro-particles of a metal, micro-particles of two or more metals, or a composite of one or more metals and other materials.

Spreader 2022 may be movable across powder bed 2024 to spread a layer of powder, from powder supply 2020, across powder bed 2024. Print head 2026 may comprise a discharge orifice 2030 and, in certain implementations, may be actuated to dispense a binder material 2032 (e.g., through delivery of an electric current to a piezoelectric element in mechanical communication with binder material 2032) through discharge orifice 2030 to the layer of powder spread across powder bed 2024. In some embodiments, the binder material 2032 may be one or more fluids configured to bind together powder particles.

In operation, controller 2028 may actuate print head 2026 to deliver binder material 2032 from print head 2026 to each layer of the powder in a pre-determined two-dimensional pattern, as print head 2026 moves across powder bed 2024. In embodiments, the movement of print head 2026, and the actuation of print head 2026 to deliver binder material 2032, may be coordinated with movement of spreader 2022 across powder bed 2024. For example, spreader 2022 may spread a layer of the powder across powder bed 2024, and print head 2026 may deliver the binder in a pre-determined, two-dimensional pattern, to the layer of the powder spread across powder bed 2024, to form a layer of one or more three-dimensional objects 2034. These steps may be repeated (e.g., with the pre-determined two-dimensional pattern for each respective layer) in sequence to form subsequent layers until, ultimately, the one or more three-dimensional objects 2034 are formed in powder bed 2024.

Although the example embodiment depicted in FIG. 21B depicts a single object 2034 being printed, it should be understood that the powder bed 2024 may include more than one object 2034 in embodiments in which more than one object 2034 is printed at once. Further, the powder bed 2024 may be delineated into two or more layers, stacked vertically, with one or more objects disposed within each layer.

An example binder jet fabrication subsystem 2002 may comprise a powder supply actuator mechanism 2036 that elevates powder supply 2020 as spreader 2022 layers the powder across powder bed 2024. Similarly, build box subsystem 2008 may comprise a build box actuator mechanism 2038 that lowers powder bed 2024 incrementally as each layer of powder is distributed across powder bed 2024.

In another example embodiment, layers of powder may be applied to powder bed 2024 by a hopper followed by a compaction roller. The hopper may move across powder bed 2024, depositing powder along the way. The compaction roller may be configured to follow the hopper, spreading the deposited powder to form a layer of powder.

For example, FIG. 21C illustrates another binder jet fabrication subsystem 2002′ operating in conjunction with a build box subsystem 2008′. In this aspect, binder jet fabrication subsystem 2002′ may include a powder supply 2020′ in a metering apparatus, for example, a hopper 2021. Binder jet subsystem 2002′ may also include one or more spreaders 2022′ (e.g., one or more rollers) configured to be movable across powder bed 2024′ of build box subsystem 2008′, a print head 2026′ movable across powder bed 2024′, and a controller 2028′ in electrical communication (e.g., wireless, wired, Bluetooth, etc.) with one or more of hopper 2021, spreaders 2022′, and print head 2026′. Powder bed 2024′ may comprise powder particles, for example, micro-particles of a metal, micro-particles of two or more metals, or a composite of one or more metals and other materials.

Hopper 2021 may be any suitable metering apparatus configured to meter or deliver powder from powder supply 2020′ onto a top surface 2023 of powder bed 2024′. Hopper 2021 may be movable across powder bed 2024′ to deliver powder from powder supply 2020′ onto top surface 2023. The delivered powder may form a pile 2025 of powder on top surface 2023.

The one or more spreaders 2022′ may be movable across powder bed 2024′ downstream of hopper 2021 to spread powder, e.g., from pile 2025, across powder bed 2024. The one or more spreaders 2022′ may also compact the powder on top surface 2023. In either aspect, the one or more spreaders 2022′ may form a layer 2027 of powder. The aforementioned powder delivery and spreading steps may be successively performed in order to form a plurality of layers 2029 of powder. Additionally, although two spreaders 2022′ are shown in FIG. 21C, binder jet fabrication subsystem 2002′ may include one, three, four, etc. spreaders 2022′.

Print head 2026′ may comprise one or more discharge orifices 2030′ and, in certain implementations, may be actuated to dispense a binder material 2032′ (e.g., through delivery of an electric current to a piezoelectric element in mechanical communication with binder material 2032′) through discharge orifice 2030′ to the layer of powder spread across powder bed 2024′. In some embodiments, the binder material 2032′ may be one or more fluids configured to bind together powder particles.

In operation, controller 2028′ may actuate print head 2026′ to deliver binder material 2032′ from print head 2026′ to each layer 2027 of the powder in a pre-determined two-dimensional pattern, as print head 2026′ moves across powder bed 2024′. As shown in FIG. 21C, controller 2028′ may be in communication with hopper 2021 or the one or more spreaders 2022′ as well, for example, to actuate the movement of hopper 2021 and the one or more spreaders 2022′ across powder bed 2024′. Additionally, controller 2028′ may control the metering or delivery of powder by hopper 2021 from powder supply 2020 to top surface 2023 of powder bed 2024′. In embodiments, the movement of print head 2026′, and the actuation of print head 2026′ to deliver binder material 2032′, may be coordinated with movement of hopper 2021 and the one or more spreaders 2022′ across powder bed 2024′. For example, hopper 2021 may deliver powder to powder bed 2024, and spreader 2022′ may spread a layer of the powder across powder bed 2024. Then, print head 2026 may deliver the binder in a pre-determined, two-dimensional pattern, to the layer of the powder spread across powder bed 2024′, to form a layer of one or more three-dimensional objects 2034′. These steps may be repeated (e.g., with the pre-determined two-dimensional pattern for each respective layer) in sequence to form subsequent layers until, ultimately, the one or more three-dimensional objects 2034′ are formed in powder bed 2024′.

Although the example embodiment depicted in FIG. 21C depicts a single object 2034′ being printed, it should be understood that the powder bed 2024′ may include more than one object 2034′ in embodiments in which more than one object 2034′ is printed at once. Further, the powder bed 2024′ may be delineated into two or more layers 2027, stacked vertically, with one or more objects disposed within each layer.

As in FIG. 21C, build box subsystem 2008′ may comprise a build box actuator mechanism 2038′ that lowers powder bed 2024′ incrementally as each layer 2027 of powder is distributed across powder bed 2024′. Accordingly, hopper 2021, the one or more spreaders 2022′, and print head 2026′ may traverse build box subsystem 2008′ at a pre-determined height, and build box actuator mechanism 2038′ may lower powder bed 2024 to form object 2034′.

Although not shown, binder jet fabrication subsystems 2002, 2002′ may include a coupling interface that may facilitate the coupling or uncoupling of the build box subsystems 2008, 2008′ with the binder jet fabrication subsystems 2002, 2002′, respectively. The coupling interface may comprise one or more of (i) a mechanical aspect that provides for physical engagement, or (ii) an electrical aspect that supports electrical communication between the build box subsystem 2008, 2008′ to the binder jet fabrication subsystem 2002, 2002′.

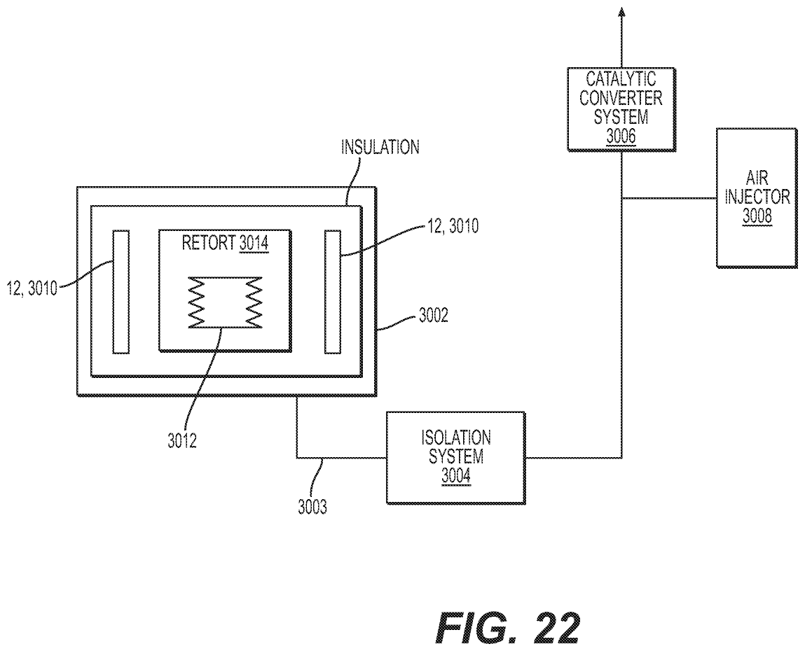

FIG. 22 is a block diagram of the furnace subsystem 1006 according to exemplary embodiments. The furnace subsystem 1006 may include a furnace chamber 3002, an isolation system 3004, a catalyst converter system 3006, and an air injector 3008 (also referred to as an oxygen injector, which may introduce air or oxygen gas into the system).

The furnace chamber 3002 may be a sealable and insulated chamber designed to enclose a controlled atmosphere substantially free of oxygen to prevent combustion. In the context of the current disclosure, a controlled atmosphere refers to an atmosphere being controlled for one or more of temperature, composition, and pressure. The furnace chamber 3002 may include one or more heating elements 3010 for heating the atmosphere enclosed within the furnace chamber 3002. Heating elements 3010 may be formed by one or more heaters 12. As shown in FIG. 22, a printed object 3012 (e.g., the printed object 1030 from metal 3D printing subsystem 1002, the printed object 2034 from binder jet fabrication subsystem 2002, or the printed object 2034′ from binder jet fabrication subsystem 2002′) may be placed in the furnace chamber 3002 for thermal processing. e.g., a thermal debinding process or a densifying process. In some embodiments, the furnace chamber 3002 may be heated to a suitable temperature as part of the thermal debinding process in order to degrade any binder components included in the printed object 3012 and then may be heated to just below a sintering temperature to densify the part. In some embodiments, the furnace chamber 302 may include heat-conductive walls (e.g., graphite walls) to spread heat generated by the heating elements 3010 within the furnace chamber 3002, thereby enhancing temperature uniformity in a region where the printed object 3012 is located. In some embodiments, the furnace chamber 3002 may include a retort 3014 comprising a graphite box with walls partially or fully enclosing the region where the printed object 3012 is located. In some embodiments, the furnace chamber 3002 may include one or more shelves on which the printed object 3012 may be placed within the furnace chamber 3002. In some embodiments, the retort 3004 may include the one or more shelves.

Gaseous effluent may be released into the atmosphere of the furnace chamber 3002 as the printed object 3012 is heated during a thermal processing, e.g., during the thermal debinding process. In some embodiments, the gaseous effluent may be pumped out of the furnace chamber 3002, flowed through the isolation system 3004, and directed towards the catalyst converter system 3006. The isolation system 3004 may be configured to prevent any downstream fluid (e.g., gas, particularly oxygen gas from air injector 3008) from flowing back towards the furnace chamber 3002. The isolation system 3004 or catalytic converter system 3006 may be configured to remove toxic fumes, e.g., at least a portion of the volatilized binder components, from the gaseous effluent.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. In this disclosure, any identification of specific techniques, arrangements, etc., are either related to a specific example presented or are merely a general description of such a technique, arrangement, etc. Identifications of specific details or examples are not intended to be, and should not be, construed as mandatory or limiting unless specifically designated as such. Any to specifically describe a combination or sub-combination of components should not be failure understood as an indication that any combination or sub-combination is not possible. It will be appreciated that modifications to disclosed and described examples, arrangements, configurations, components, elements, apparatuses, devices, systems, methods, etc., can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software.

It is intended that the specification and examples be considered as exemplary only, with a true scope and spirit of the disclosure being indicated by the following claims.

What is claimed is:

1. A furnace heater, comprising:
a first conductive lead;
a second conductive lead spaced apart from the first conductive lead by a first distance;
a first helical resistive heater element connected to the first conductive lead; and
a second helical resistive heater element connected to the second conductive lead and to the first helical resistive heater element, the second helical resistive heater element spaced apart from the first helical resistive heater by a second distance, wherein the first distance is at least twice the second distance.

2. The furnace heater of claim 1, further including an electrical insulator surrounding at least a portion of an outer periphery of the first conductive lead.

3. The furnace heater of claim 2, wherein the first conductive lead extends from a proximal end to a distal end, and an electrode is provided on the proximal end of the first conductive lead.

4. The furnace heater of claim 3, wherein a potting material is provided on a proximal portion of the first conductive lead.

5. The furnace heater of claim 4, wherein the potting material surrounds the electrode.

6. The furnace heater of claim 4, further including a cap surrounding the potting material and an outer periphery of the proximal end of the first conductive lead.

7. The furnace heater of claim 6, further including a thermally-insulating casing surrounding the first conductive lead.

8. The furnace heater of claim 1, further including:
a first transition portion fixed between the first conductive lead and the first helical resistive heater element, the first transition portion electrically connecting the first conductive lead and the first helical heater; and
a second transition portion fixed between the second conductive lead and the second helical resistive heater element, the second transition portion electrically connecting the second conductive lead and the second helical heater.

9. The furnace heater of claim 8, wherein the first conductive lead, the first transition portion, the first helical heater, the second conductive lead, the second transition portion, and the second helical heater each include silicon carbide, wherein a proximal end of the first conductive lead includes a groove within which a conductive wire is fixed, and wherein the first transition portion and the second transition portion have an electrical resistance that is higher than an electrical resistance of the conductive wire and lower than an electrical resistance of the first helical resistive heater element.

10. A furnace, comprising:
a thermal insulation layer;
a vacuum pump configured to maintain the furnace at a pressure that is lower than a pressure outside the furnace; and
a furnace heater extending from a proximal end to a distal end, the furnace heater including:
a first conductive lead;
a first helical resistive heater electrically connected to the first conductive lead;
a second conductive lead spaced apart from the first conductive lead by a first distance; and
a second helical resistive heater electrically connected to the second conductive lead and spaced apart from the first helical resistive heater by a second distance, wherein the first distance is at least twice the second distance.

11. The vacuum furnace of claim 10, further including an electrical insulator surrounding at least a portion of an outer periphery of the first conductive lead, the electrical insulating including a dielectric material.

12. The furnace of claim 11, wherein the first conductive lead extends from a proximal end to a distal end, and a potting material is provided on the proximal end of the first conductive lead.

13. The furnace of claim 11, further including an additional electrical insulator surrounding at least a portion of an outer periphery of the second conductive lead, the additional electrical insulator being spaced apart from the first electrical insulator.

14. The furnace of claim 10, further including a thermally-insulating casing surrounding the first conductive lead.

15. The furnace of claim 14, wherein the thermally-insulating casing is secured within the thermal insulation layer by at least one of an interference fit or an adhesive.

16. The furnace of claim 10, wherein the first distance is measured in a direction that is orthogonal to a longitudinal direction that extends from the proximal end toward the distal end of the furnace heater, and wherein the second distance is measured along the longitudinal direction.

17. A furnace heater, comprising:
a first electrical insulator;
a first conductive lead extending within the first electrical insulator;
a second conductive lead;
a first helical resistive heater element connected to a distal end of the first conductive lead;
a second helical resistive heater element connected to a distal end of the second conductive lead and to the first helical resistive heater element; and
an electrode formed at a proximal end of the first conductive lead.

18. The furnace heater of claim 17, further including a thermally-insulating member surrounding the first electrical insulator, the first conductive lead, and the second conductive lead.

19. The furnace heater of claim 17, further including:
a first silicon carbide transition portion fixed to the distal end of the first conductive lead and to a proximal end of the first helical resistive heater element; and
a second silicon carbide transition portion fixed to the distal end of the second conductive lead and to a proximal end of the second helical resistive heater element.

20. The furnace heater of claim 17, wherein the first conductive lead and the second conductive lead area spaced apart by a first distance, and the first helical resistive heater element and second helical resistive heater element are spaced apart by a second distance, and the first distance is at least twice as large as the second distance.
